(19) United States
(12) Patent Application Publication
(10) Pub. No.: US 2024/0091686 A1
(43) Pub. Date: Mar. 21, 2024

(54) WATER PURIFIER

(71) Applicants: LG Electronics Inc., Seoul (KR); Cheonghosystem Co. Ltd., Seoul (KR)

(72) Inventors: Youngjae KIM, Seoul (KR); Soongy JEONG, Seoul (KR); Jingyu JI, Seoul (KR); Hyeonggeun KIM, Seoul (KR); Yongwoon PARK, Seoul (KR)

(21) Appl. No.: 18/370,188

(22) Filed: Sep. 19, 2023

(30) Foreign Application Priority Data
Sep. 19, 2022 (KR) 10-2022-0118004
Sep. 21, 2022 (KR) 10-2022-0119059

(51) Int. Cl. B01D 35/30; B01D 29/50; C02F 1/00

(52) U.S. Cl. CPC B01D 35/30; B01D 29/50; C02F 1/003; B01D 2201/303; B01D 2201/4023; C02F 2307/10

(57) ABSTRACT

A water purifier includes a water purifier main body having a front panel forming a front surface, first and second side panels forming both side surfaces, a top cover forming an upper surface, a rear cover forming a rear surface, and a base forming a bottom surface and in which a filter is accommodated; a fixed cover provided with an elevation space therein in a vertical direction and fixed to the upper surface of the water purifier main body, a water outlet nozzle exposed to a lower end of the fixed cover, and a filter housing disposed inside the water purifier main body and in which a filter accommodating groove in which the filter is accommodated is concave backward, and in which a downwardly concave filter groove is formed in the base to accommodate the lower end of the filter.

### CROSS-REFERENCE TO RELATED APPLICATIONS

The present application claims priority under 35 U.S.C. 119 and 35 U.S.C. 365 to Korean Patent Application No. 10-2022-0118004, filed on Sep. 19, 2022, and Korean Patent Application No. 10-2022-0119059, filed on Sep. 21, 2022, the disclosures of which are hereby incorporated by reference in their entirety.

### TECHNICAL FIELD

The present disclosure relates to a water purifier having a filter.

### BACKGROUND

Water dispensing devices such as water purifiers and refrigerators refer to devices that purify raw water such as tap water or underground water. For example, the water dispensing devices my convert raw water into drinking water through various purification methods and providing the drinking water.

In order to produce purified water, processes such as precipitation, filtration, and sterilization may be performed, and harmful substances are generally removed through such processes.

A water dispensing device may include various filters to purify raw water. These filters may be classified into a sediment filter, an activated carbon filter, an ultrafiltration (UF) hollow fiber membrane filter, a reverse osmosis (RO) membrane filter, and the like according to their functions.

The sediment filter may precipitate large-particle contaminants or suspended matter in raw water, and the activated carbon filter may adsorb and remove small-particle contaminants, residual chlorine, volatile organic compounds, or odor generating factors.

In some cases, two activated carbon filters may be provided. For example, a pre-activated carbon filter may be provided on the raw water side, and a post-activated carbon filter may be provided on the purified water side. The post-activated carbon filter may improve the taste of water by removing odor-causing substances that mainly affect the taste of purified water.

In some cases, both the UF hollow fiber membrane filter and the RO membrane filter are selectively used.

In some cases, a refrigerator may include a filter that purifies incoming water and then discharges the water; a head including an inlet through which raw water is introduced and an outlet through which purified water is discharged, and to which the filter is detachably coupled; a shaft rotatably mounted between the inlet and the outlet inside the head and having a filtering flow path which is connected to discharge the water introduced into the inlet via the filter and a bypass flow path which directly connects the inlet and the outlet to each other; a first connection portion provided at an end portion of the filter; and a second connection portion formed in a shape corresponding to the first connection portion at the center of rotation of the shaft and coupled to the first connection portion when the filter is mounted, in which the shaft rotates according to rotation of the filter and thus the filtering flow path or the bypass flow path is connected to the inlet and outlet.

In order to couple the filter head to the filter bracket, the filter head is pushed into the filter bracket and then the filter head is rotated.

In some cases, where the filter head is inserted into the filter bracket in a press-fitting method and then the filter head is rotated, friction may occur between components, the fastening torque may be increased, a lot of force may be applied when replacing the filter, and the difficulty of the filter replacement operation is increased.

In some cases, where the filter head is not fastened to the filter bracket, the flow path is connected, and unfiltered tap water flows through the water outlet nozzle, causing the user to drink the tap water.

In some cases, when the filter head is not completely fastened to the filter, the flow path may become clogged, water may not flow, and the water pressure may increase, which may cause damage to components or leakage, and water may not exit through the water outlet nozzle.

In some cases, as the number of components installed on the flow path through which water flows increases, resistance to the flow of water increases, thereby reducing the flow rate.

In some cases, the filter main body may be separated from the filter head when the filter head is separated from the filter bracket or when the filter head is mounted on the filter bracket because a structure for holding the filter so that it is not separated from the filter head is not applied.

In some cases, when the filter is separated or installed for filter replacement, leakage may occur in the process of separating the filter head from the filter bracket or coupling the filter head to the filter bracket, and the leaked water flows out to the floor.

### SUMMARY

The present disclosure describes a water purifier that provides a push-pull method that presses and pulls when replacing a filter, where the filter can be easily and conveniently replaced, and thus the difficulty of work is reduced, and the user can directly replace the filter.

The present disclosure further describes a water purifier capable of reducing flow resistance, increasing treatment flow rate, and reducing the risk of leakage by reducing the number of components such as a shaft disposed in a path through which water flows.

The present disclosure further describes a water purifier that can automatically block the incoming of raw water to prevent or reduce leakage when replacing the filter.

The present disclosure further describes a water purifier that drains water automatically after replacing the filter such that the water after washing the filter is not supplied as drinking water.

The present disclosure further describes a water purifier that is capable of completing a housing of the water purifier by assembling while components forming the outer appearance of the water purifier are mutually coupled.

The present disclosure further describes a water purifier including a water outlet nozzle through which water is ejected and that moves up and down.

In some examples, since the position of the water outlet nozzle can be changed not only in the vertical direction but also in the horizontal direction, a water purifier can provide user convenience.

The present disclosure describes a water purifier in which a lower end of a filter can be fixed to a base. In addition, a water purifier is provided which, when the filter is separated or coupled, even if water leakage occurs between the filter head and the filter bracket, leaked water can be collected.

In addition, a water purifier is provided in which, when filter replacement is performed, difficulties occurring in assembly and separation processes due to the rotational detachable structure are resolved, thereby filter replacement can be performed easily and conveniently.

According to one aspect of the subject matter described in this application, a water purifier includes a filter bracket connected to a water supply flow path, the filter bracket being configured to couple to a filter, the filter including (i) a filter main body and (ii) a filter head disposed at an upper end of the filter main body. The filter bracket and the filter head are configured to couple to each other in a horizontal direction and to separate from each other in the horizontal direction. The filter head includes (i) an incoming pipe that extends in the horizontal direction and is configured to guide water to the filter main body and (ii) a discharge pipe that extends parallel to the incoming pipe and is configured to discharge water from the filter main body. The filter bracket defines a first groove that extends in the horizontal direction and is configured to receive the incoming pipe in the horizontal direction, and a second groove that extends in the horizontal direction and is configured to receive the discharge pipe in the horizontal direction.

Implementations according to this aspect can include one or more of the following features. For example, the filter bracket includes a blocking wall that is disposed between the first groove and the second groove and partitions the first groove and the second groove from each other. In some examples, the filter bracket can include a main flow path that extends in a lateral direction intersecting the horizontal direction, the main flow path having (i) an inlet side configured to receive raw water from the water supply flow path and (ii) an outlet side configured to discharge purified water from the filter main body.

In some examples, the first groove of the filter bracket is configured to supply the raw water received through the inlet side of the main flow path to the filter main body through the incoming pipe of the filter head, and the second groove of the filter bracket is configured to receive the purified water discharged from the discharge pipe of the filter head and to discharge the purified water through the outlet side of the main flow path.

In some implementations, the filter bracket can further include an inlet flow path connected to the inlet side of the main flow path and configured to provide the raw water to the main flow path, and a water outlet flow path connected to the outlet side of the main flow path and configured to discharge the purified water. In some examples, at least one end portion of the main flow path defines an opening, and the filter bracket can include a stopper that is inserted into and blocks the opening of the at least one end portion of the main flow path. In some implementations, the main flow path can have a first stepped portion that is defined at an inner surface of the at least one end portion of the main flow path, and the stopper can have a second stepped portion that faces the first stepped portion.

In some implementations, the water purifier can be configured to receive a plurality of filters, where the filter bracket is one of a plurality of filter brackets including a first filter bracket configured to receive one of the plurality of filters, and a second filter bracket connected to one side of the first filter bracket and configured to receive another of the plurality of filters.

In some implementations, the water purifier can further include a water purifier main body, and the filter bracket can include an extension wall that extends downward and is fixed to the water purifier main body of the water purifier. In some implementations, the water purifier can further include a fixing member rotatably disposed at the filter bracket and configured to selectively fix the filter head to the filter bracket, the fixing member being configured to rotate about an axis crossing the horizontal direction. In some examples, the fixing member is configured to rotate in a forward direction toward the filter head, where the filter head can include a side portion that is convex in the forward direction and configured to contact at least a portion of the fixing member based on the fixing member rotating in the forward direction. The fixing member can be configured to restrict movement of the filter head based on rotating in the forward direction and contacting the side portion of the filter head. In some implementations, the fixing member can include a gripping portion that extends outward from a lower end of the fixing member and enables handling of the fixing member.

In some implementations, the filter bracket can include a first protrusion that extends in the horizontal direction and defines the first groove therein, a second protrusion that extends in the horizontal direction defines the second groove therein, a first shaft portion that extends outward from the first protrusion in a first direction, and a second shaft portion that extends outward from the second protrusion in a second direction opposite to the first direction, where end portions of the fixing member are rotatably coupled to the first and second shaft portions, respectively.

In some implementations, the filter head can include a locking protrusion that protrudes forward from a front surface of the filter head, and the fixing member defines a locking groove configured to couple to the locking protrusion based on the fixing member rotating forward toward the filter head. In some implementations, the filter main body can include a filter cap coupled to the filter head, the filter cap including a protrusion, and the filter head defines an opening that exposes the protrusion of the filter cap to an outside of the filter head.

In some examples, the filter head can include a rib that is coupled to one side surface of the protrusion based on being elastically deformed, where the rib is disposed at a side of the opening and exposed to the outside of the filter head through the opening. In some examples, the rib has a convex shape toward an inside of the filter head.

In some implementations, the water purifier can include a water purifier main body configured to accommodate the filter, where the water purifier main body includes a front panel that defines a front surface of the water purifier, a first side panel and a second side panel that defines side surfaces of the water purifier, respectively, a top cover that defines an upper surface of the water purifier, a rear cover that defines a rear surface of the water purifier, and a base that defines a bottom surface of the water purifier, where the base defines a filter groove that is recessed downward and configured to accommodate a lower end of the filter main body.

The water purifier can further include a fixed cover that is fixed to the top cover of the water purifier main body and defines an elevation space therein extending in a vertical direction, a water outlet nozzle exposed to a lower end of the fixed cover, and a filter housing disposed inside the water purifier main body, where the filter housing defines a filter accommodating groove that is recessed rearward away from the front panel and configured to accommodate the filter.

In some examples, the filter groove is one of a plurality of filter grooves that are defined at the base and configured to accommodate lower ends of a plurality of filters, respectively. In some examples, the base can include intermediate protrusions that are disposed between the plurality of filter grooves and partition the plurality of filter grooves from one another. In some examples, the front panel can be configured to be separated from the water purifier main body to thereby expose the filter accommodating groove or the filter accommodated in the filter accommodating groove to an outside of the water purifier.

In some implementations, the base protrudes upward from the front end and extends in a horizontal direction to form an extension rib contacting and supporting the lower end of the filter.

In some implementations, at least a portion of the surface forming the filter groove is formed as a curved surface. In some examples, at least a portion of the fixing member has a shape of a semicircle convex forward.

### BRIEF DESCRIPTION OF THE DRAWINGS

FIG. 1 is a perspective view illustrating an example of a water purifier.

FIG. 2 is a perspective view illustrating an example state where the position of the water outlet nozzle of the water purifier in FIG. 1 is changed.

FIG. 3 is a perspective view illustrating an example state where the fixed cover and the top cover are separated from each other in FIG. 1.

FIG. 4 is a perspective view illustrating an example state where the fixed cover is rotated to one side in FIG. 1.

FIG. 5 is a perspective view illustrating an example state where the fixed cover is rotated to the other side in FIG. 1.

FIG. 6 is a view illustrating an example state where the front panel is separated from FIG. 1.

FIG. 7 is a view illustrating an example state where the filter bracket and the filter are separated.

FIGS. 8A and 8B are views illustrating example states where the filter is fixed by lowering the fixing member in a state where the filter is mounted on the filter bracket.

FIG. 9 is a longitudinal sectional view illustrating an example of a fixing member.

FIG. 10 is a longitudinal sectional view illustrating another example of a fixing member.

FIG. 11 is a front view illustrating an example of a filter mounted on a filter bracket.

FIG. 12 is a side view illustrating an example state where a filter is mounted on a filter bracket.

FIG. 13 is a front view illustrating an example state where a filter cap and a filter head are coupled.

FIG. 14 is a perspective view illustrating the fixing member.

FIG. 15 is a perspective view illustrating the filter head.

FIG. 16 is a perspective view illustrating an example of a filter bracket.

FIG. 17 is a perspective view illustrating an example of a filter socket.

FIG. 18 is an exploded perspective view illustrating examples of a filter head and a filter bracket.

FIG. 19 is a view illustrating the flow path of water in the filter bracket.

FIG. 20 is a view illustrating an example state without filters in FIG. 6.

FIG. 21 is an exploded front view illustrating the housing and the filter housing in a disassembled state.

FIG. 22 is an exploded rear view illustrating the housing and the filter housing in a disassembled state.

FIG. 23 is an enlarged view illustrating a portion of FIG. 20.

FIG. 24 is an enlarged view illustrating the front end of the base.

FIG. 25 is a view illustrating an example state where the filter housing and the base are assembled.

FIG. 26 is an enlarged view illustrating a portion of FIG. 25.

FIG. 27 is a longitudinal sectional view of FIG. 26.

FIG. 28 is an example of a water piping diagram of a water purifier.

### DETAILED DESCRIPTION

Hereinafter, one or more implementations of the present disclosure will be described in detail with reference to the drawings.

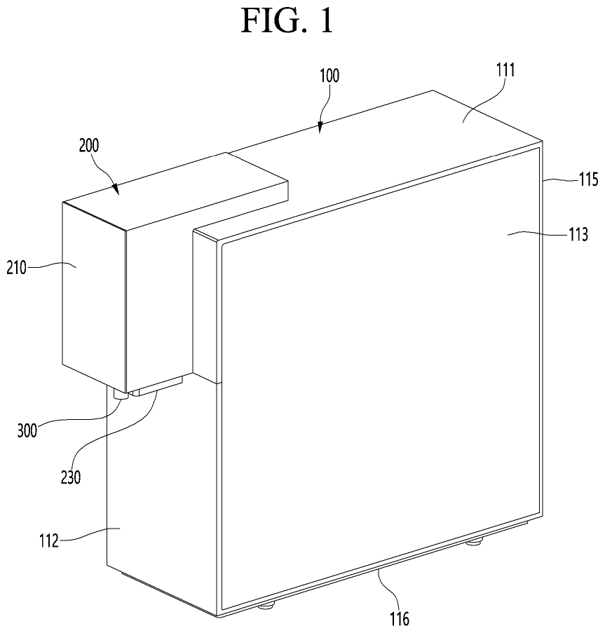

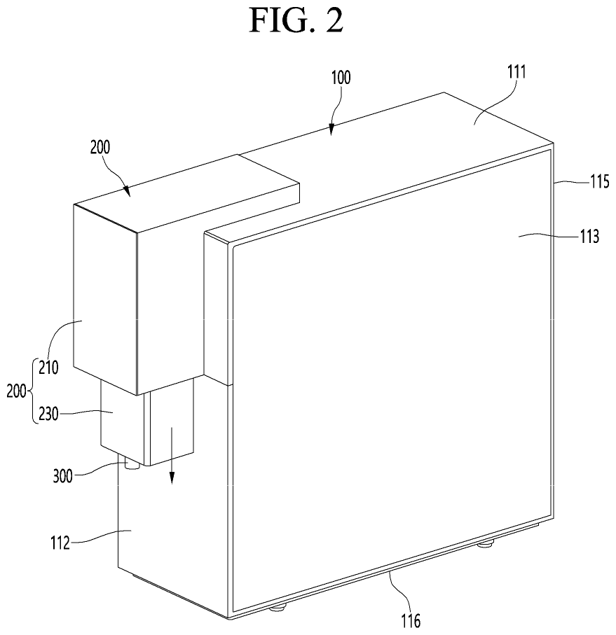

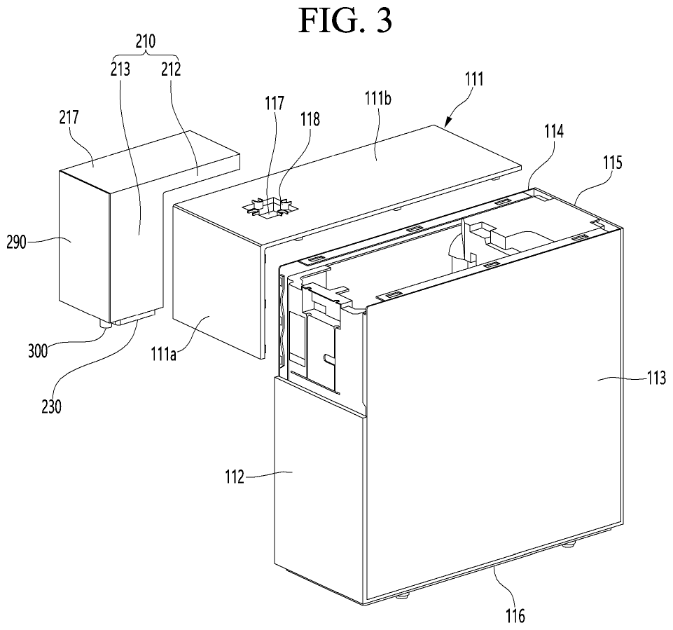

FIG. 1 is a perspective view illustrating an example of a water purifier, FIG. 2 is a perspective view illustrating an example state where the position of the water outlet nozzle of the water purifier in FIG. 1 is changed, and FIG. 3 is a perspective view illustrating an example state where the fixed cover and the top cover are separated from each other in FIG. 1.

FIG. 1 illustrates a water dispensing device configured to receive a filter module.

In some implementations, the water purifier can discharge water supplied from an external water supply source immediately after purifying it, or can discharge water by cooling or heating it, which can provide, for example, a direct water purifier.

In some implementations, the direct water purifier refers to a type of water purifier in which water passes through a filter in real time and the purified water is ejected when a user requests to eject purified water without a water storage tank storing purified water. In some implementations, the water purifier can be applied to a refrigerator having a water purifying function. For example, a refrigerator with a water purifier can include a filter for purifying raw water and a water outlet nozzle for ejecting purified water. In some implementations, the water purifier can be applied to an undersink type water purifier in which a main body is installed under a sink and a water outlet nozzle is installed outside the sink. As such, the water purifier can refer to various types of well-known devices that receive water from a water supply source, pass through a filter to purify water, and then supply the water to the outside.

In some implementations, referring to FIGS. 1 to 3, a water purifier includes a water purifier main body 100, and a water outlet module 200 and a water outlet pipe 400 which couple to the water purifier main body 100 and have a water outlet nozzle 300 mounted on the lower end thereof.

In some examples, the water outlet module 200 can include a fixed cover 210 and a water outlet nozzle 300. The water outlet module 200 can include a fixed cover 210, an elevation cover 230, and a water outlet nozzle 300.

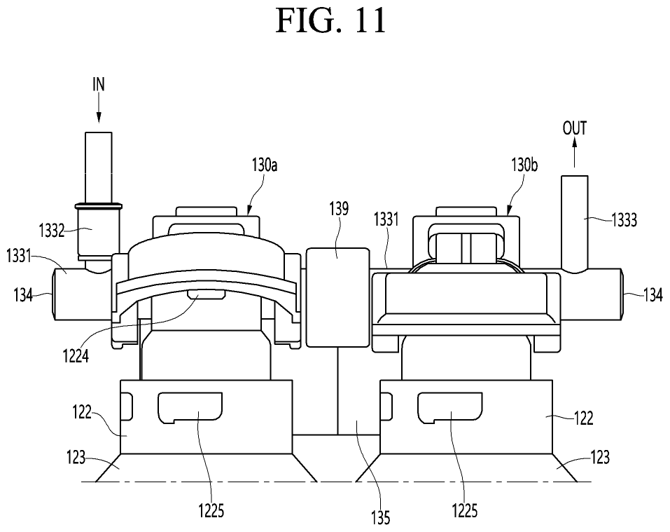

In some examples, the water outlet module 200 can include a fixed cover 210, an elevation cover 230, a water outlet nozzle 300, and a fixed bracket 220 (see FIG. 11).

In some examples, the water outlet module 200 can have an elevation structure so that the height of the water outlet nozzle 300 is adjusted.

In some examples, the water outlet module 200 can be coupled to protrude from the front surface of the water purifier main body 100. In addition, the water outlet module 200 can be coupled to protrude from either the left side surface or the right-side surface of the water purifier main body 100.

The water outlet module 200 can be coupled to an upper surface of the water purifier main body 100. The opening 117 through which the water outlet pipe 400 extending from the inside of the water purifier main body 100 and connected to the water outlet nozzle 300 through the inner space of the water outlet module 200, electric wires, or the like pass passes through the opening formed on the upper surface of the water purifier main body 100.

The water outlet module 200 can be detachably coupled to the upper surface of the water purifier main body 100, and the water outlet module 200 can cover the opening.

As described above, when the opening 117 is formed on the upper surface of the water purifier main body 100, even in a case where the water outlet module 200 is installed to protrude from the front of the water purifier main body 100 or to protrude from the side of the water purifier main body 100. the front or side surface of the water purifier main body 100 is kept smooth, so that the water purifier looks clean in appearance.

First, the water purifier main body 100 includes a housing 110 forming an outer shape.

For example, the housing 110 can include a top cover 111 forming an upper surface, a front panel 112 forming a front surface, first and second side panels 113 and 114 forming both side surfaces, and a rear panel 115 forming a rear surface, and a base 116 forming a bottom surface.

The housing 110 can have a hexahedral box shape. The housing 110 can be provided in a rectangular parallelepiped shape. The housing 110 can have a length in the vertical direction longer than the length in the horizontal direction, based on the front panel 112. In addition, the housing 110 can have a length in the front and rear direction longer than the length in the left and right direction, based on the top cover 111. In addition, the housing 110 can have a similar horizontal length and a similar vertical length, based on the first and second side panels 113 and 114.

The housings 110 can be coupled to each other in an assembling manner. Therefore, in a state where the housing 110 is assembled in a box shape, the user can separate and then reassembled at least one of the top cover 111, front panel 112, first and second side panels 113 and 114, rear panel 115, and base 116.

In addition, a filter is disposed inside the housing 110 to receive water introduced from the outside and filter it into purified water.

Inside the housing 110, a filter housing 140 is disposed adjacent to the front panel 112 and has a filter accommodating groove 141 concave backward to accommodate the filter. Accordingly, when the user separates the front panel 112, the filter accommodating groove 141 and the filter disposed in the filter accommodating groove 141 can be exposed to the outside.

In addition, purified water that has passed through the filter can be supplied to the user through the water outlet nozzle 300. A purified water flow path can be disposed inside the housing 110 to guide purified water passing through the filter toward the water outlet nozzle 300.

In addition, purified water purified while passing through the filter can be cooled or heated and then supplied to the water outlet nozzle 300 in the form of cold water or hot water.

To this end, a hot water tank for heating the purified water passing through the filter and a hot water flow path for guiding the hot water heated in the hot water tank toward the water outlet nozzle 300 can be disposed inside the housing 110. For example, the hot water tank can instantaneously heat purified water passing through the hot water tank using an induction heating (IH) method to generate hot water.

In addition, the hot water tank can have a thermoelectric element or a heating wire to heat purified water passing through the hot water tank into hot water.

In addition, instead of the induction heating method, various heating methods can be applied within a range capable of heating purified water passing through the hot water tank to hot water.

In addition, a cooling tank for cooling the purified water passing through the filter and a cold-water flow path for guiding the cold water cooled in the cooling tank toward the water outlet nozzle 300 can be disposed inside the housing 110. For example, the cooling tank can include a compressor, an evaporator, a condenser, a cooling fan, and the like, so that purified water passing through the cooling tank can be cooled with cold water. In addition, the cooling tank can include a thermoelectric element to cool purified water passing through the cooling tank with cold water.

In addition, various cooling devices can be applied within a range capable of cooling purified water passing through the cooling tank with cold water instead of the evaporator.

In some implementations, the height of the water outlet nozzle 300 is variable. For instance, the water outlet nozzle 300 is provided to move up and down.

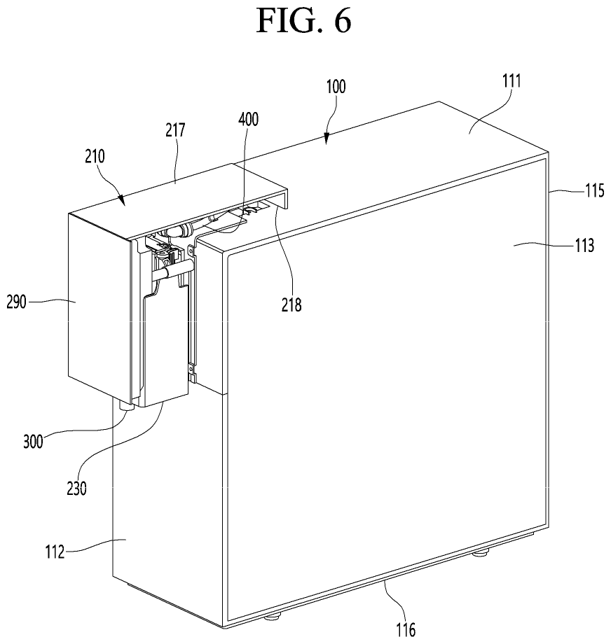

A structure in which the height of the water outlet nozzle 300 is variable as described above will be described later with reference to FIGS. 6 to 8.

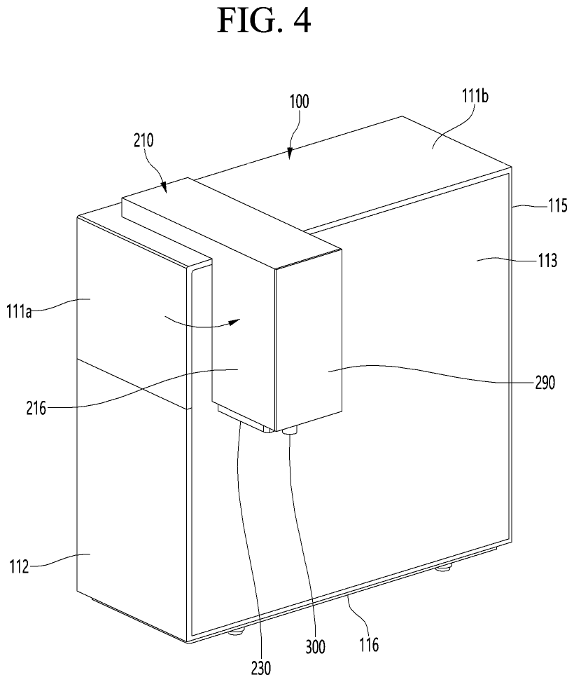

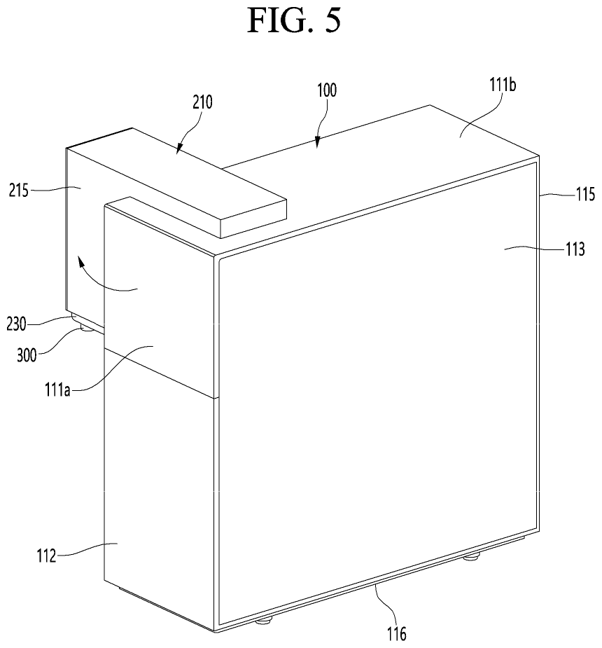

FIG. 4 is a perspective view illustrating a state where the fixed cover is rotated to one side in FIG. 1, and FIG. 5 is a perspective view illustrating a state where the fixed cover is rotated to the other side in FIG. 1.

In some implementations, referring to FIGS. 4 and 5, the position of the water outlet nozzle 300 in the horizontal direction can be changed. For example, the positions of the fixed cover 210, the elevation cover 230, and the water outlet nozzle 300 in the horizontal direction can be changed.

For example, the horizontal position of the water outlet nozzle 300 can be changed at intervals of 90°.

Referring to FIGS. 4 and 5, the fixed cover 210, the elevation cover 230, and the water outlet nozzle 300 can be installed to face one side, not the front surface, or can be installed to face the other side.

FIG. 6 is a view illustrating a state where the front panel is separated from FIG. 1.

In some examples, referring to FIG. 6, the water purifier can include a filter housing 140 disposed inside the water purifier main body 100.

In some examples, when the front panel 112 is separated from the water purifier main body 100, the filter 120 is exposed to the outside of the front.

Therefore, when replacing the filter 120, the front panel 112 can be opened and the filter 120 can be removed or installed.

A lower end of the front panel 112 can be spaced apart from a bottom surface on which the water purifier main body 100 is placed. In addition, the front panel 112 can be separated by inserting a hand into the space spaced apart from the front panel 112 and the bottom surface.

In addition, contact protrusions 1131 and 1141 are respectively formed at lower ends of the first and second side panels 113 and 114.

The first side panel 113 has a contact protrusion 1131 extending toward the second side panel 114 at its lower end, and the second side panel 113 has a contact protrusions 1141 extending toward the first side panel 113 at its lower end.

In other words, the contact protrusions 1131 and 1141 extend in directions facing each other.

The second coupling portion 150 is fastened from the front to the rear of the contact protrusions 1131 and 1141, so that the first and second side panels 113 and 114 can be fixed to the water purifier main body.

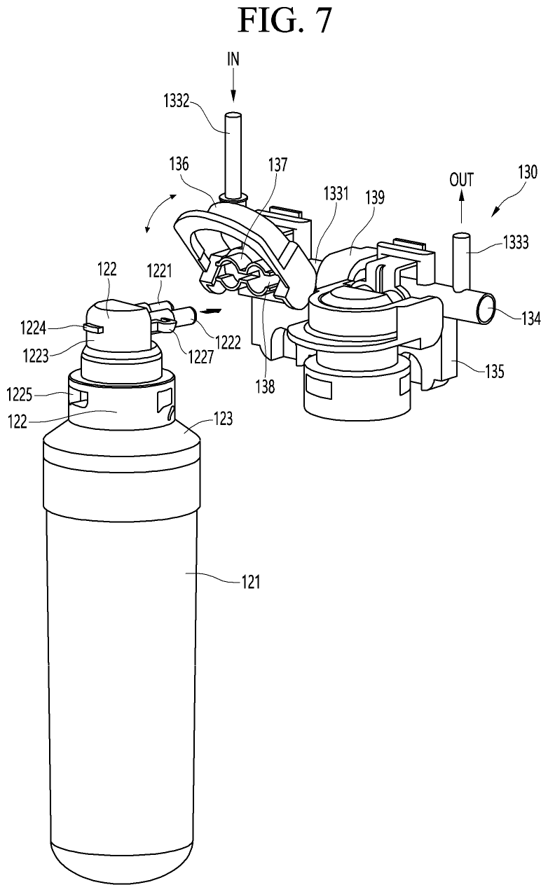

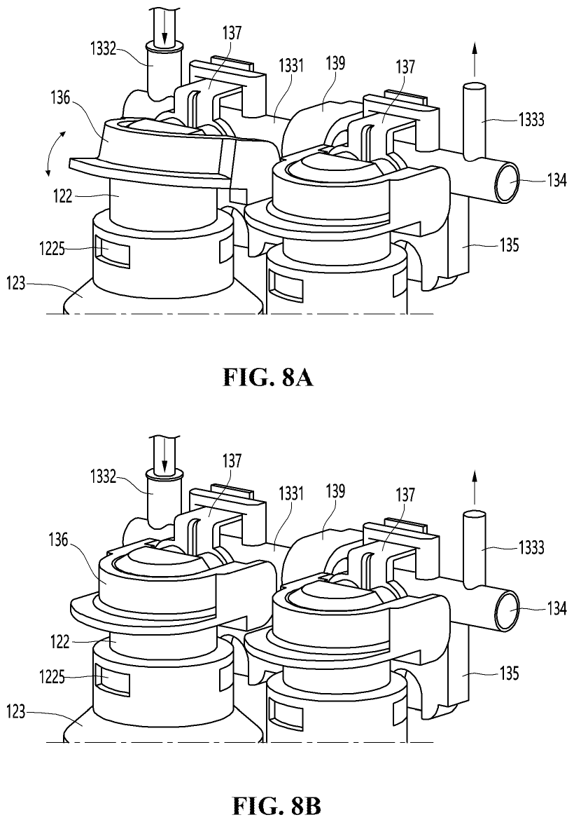

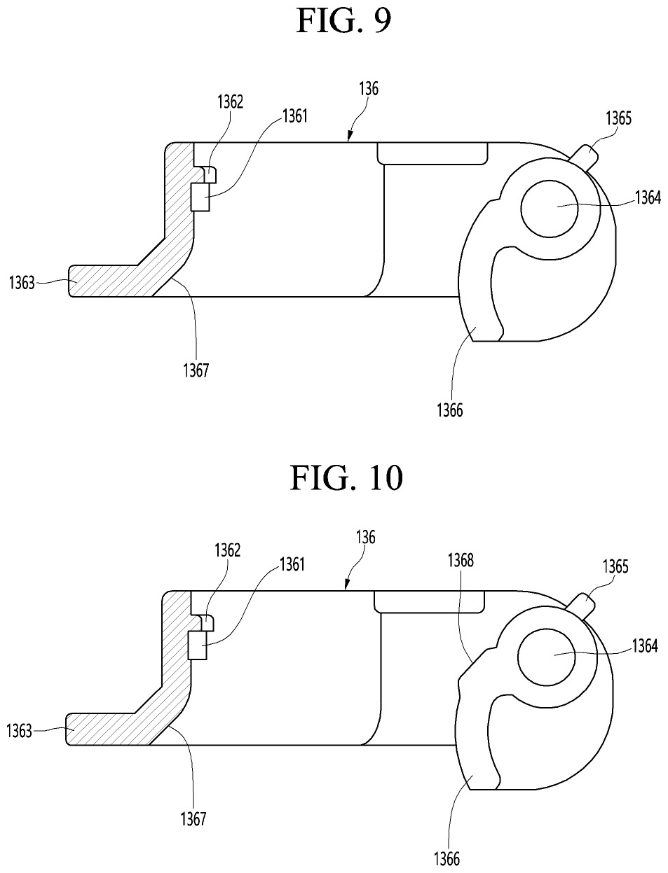

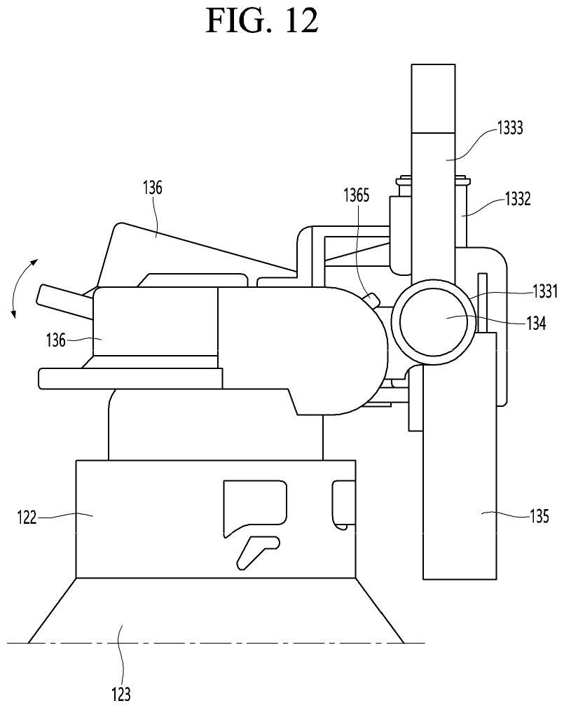

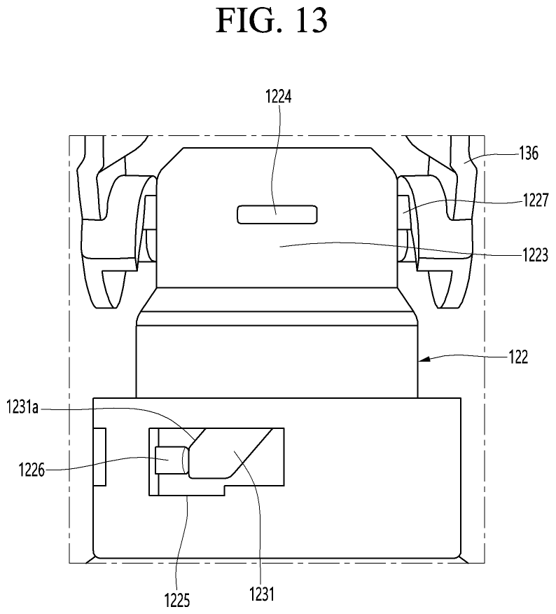

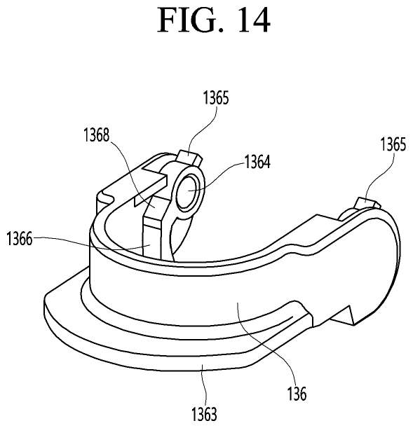

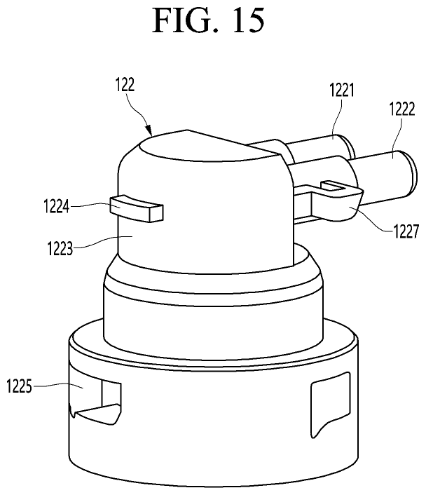

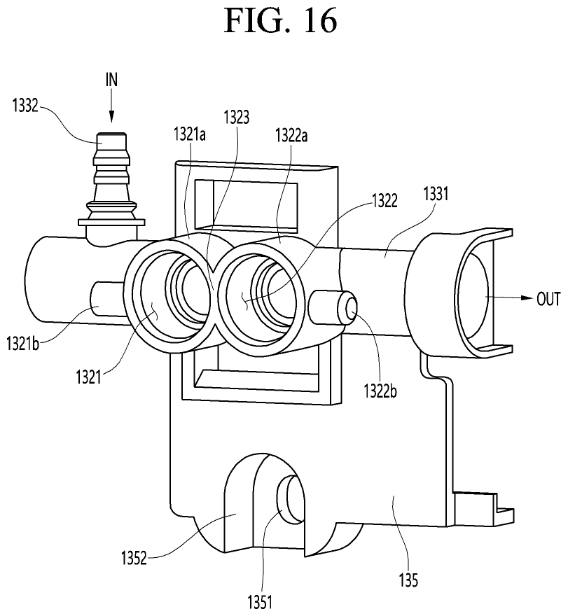

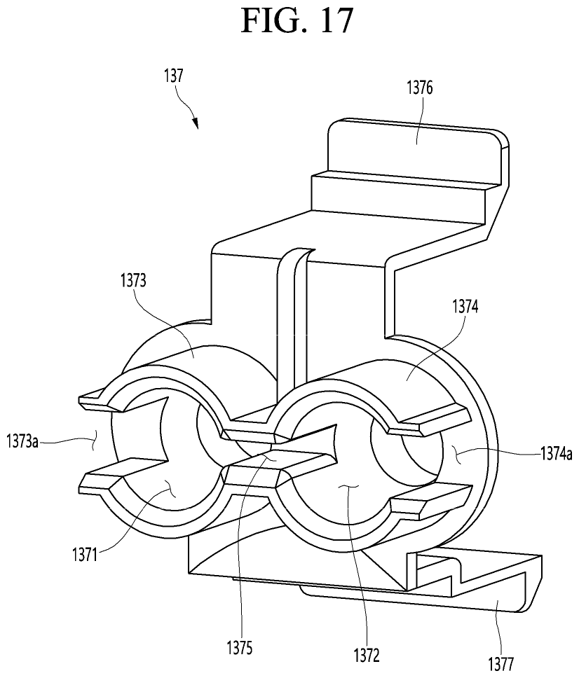

FIG. 7 is a view illustrating a state where the filter bracket and the filter are separated, FIGS. 8A and 8B are views illustrating example states where the filter is fixed by lowering the fixing member in a state where the filter is mounted on the filter bracket, FIG. 9 is a longitudinal sectional view illustrating an example of a fixing member, FIG. 10 is a longitudinal sectional view illustrating another example of a fixing member, FIG. 11 is a front view illustrating a state where a filter is mounted on a filter bracket, FIG. 12 is a side view illustrating a state where a filter is mounted on a filter bracket, FIG. 13 is a front view illustrating a state where a filter cap and a filter head are coupled, FIG. 14 is a perspective view illustrating the fixing member separated, FIG. 15 is a perspective view illustrating the filter head separated, and FIG. 16 is a perspective view illustrating a filter bracket separated.

In some implementations, referring to FIGS. 7 to 16, the water purifier can include a filter main body 121, a filter head 122 provided at an upper end of the filter main body 121, and a filter bracket 130 to which the filter head 122 are coupled and which is connected to the water supply flow path through which raw water is introduced.

Inside the filter main body 121, various filtering member can be accommodated. For example, a carbon block, a hollow fiber membrane filter, an electrostatic adsorption material, an ion exchange resin, and the like can be accommodated in the filter main body 121.

In some implementations, water introduced into the upper portion of the filter main body 121 flows downward and then flows from the lower portion to the upper portion, while being filtered and discharged to the upper portion of the filter main body 121. In addition, the filter head 122 is coupled to the upper end of the filter main body 121.

The filter head 122 includes an incoming pipe 1221 extending in a horizontal direction through which water is introduced and a discharge pipe 1222 extending in a horizontal direction parallel to the incoming pipe 1221 through which water is discharged.

The incoming pipe 1221 and the discharge pipe 1222 can extend parallel to each other in the same direction. For example, the incoming pipe 1221 and the discharge pipe 1222 can extend rearward to be coupled from the front of the filter bracket 130.

The filter bracket 130 includes a first groove 1321 formed in a horizontal direction so that the incoming pipe 1221 is inserted in a horizontal direction, and a second groove 1322 extending in a horizontal direction so that the discharge pipe 1222 is inserted in a horizontal direction, and thus the filter head 122 can be coupled to or separated from the filter bracket 130 in a horizontal direction.

In detail, the filter head 122 can be coupled to the filter bracket 130 while moving horizontally from the front to the rear of the water purifier.

In some examples, the filter head 122 can be separated from the filter bracket 130 while moving horizontally from the rear to the front of the water purifier.

In addition, a blocking wall 1323 can be formed between the first grooves 1321 and the second groove 1322 to partition the first grooves 1321 and the second groove 1322.

A distance between the first groove 1321 and the second groove 1322 can be secured by the blocking wall 1323, and the first groove 1321 and the second groove 1322 can be partitioned.

In addition, the filter bracket 130 includes a main flow path 1331 extending in the left and right direction and having a side into which raw water is introduced and the other side to which purified water is discharged, and the first groove 1321 and the second groove 1322 extends in the front and rear direction, so that water introduced into one side of the main flow path 1331 is introduced into the filter main body 121 through the first groove 1321 and the incoming pipe 1221, and the purified water discharged from the filter main body 121 can be discharged to the other side of the main flow path 1331 through the discharge pipe 1222 and the second groove 1322.

In addition, the filter bracket 130 can further include an inlet flow path 1332 which extends in the vertical direction or the front and rear direction and is connected to one side of the main flow path 1331 and through which raw water is introduced, and a water outlet flow path 1333 which extends in the vertical direction or in the front and rear direction and is connected to the other side of the main flow path 1331 and through which purified water is discharged.

Through the inlet flow path 1332, raw water is introduced from the upper side to the lower side or from the rear to the front. Then, raw water flows through the main flow path 1331 and is introduced into the filter main body 121 through the first groove 1321 and the incoming pipe 1221.

Then, the raw water is filtered as purified water while passing through the inside of the filter main body 121.

In addition, the purified water discharged to the outside of the filter main body 121 is discharged to the other side of the main flow path 1331 through the discharge pipe 1222 and the second groove 1322, and then is finally discharged to the water outlet flow path 1333 connected to the other side of the main flow path 1331.

Then, purified water is discharged from the lower side to the upper side or from the front to the rear through the water outlet flow path 1333.

In addition, one or both end portions of the main flow path 1331 are open and define opening(s) 1331a, and a stopper 134 can be inserted into the opening 1331a at one or both open end portions of the main flow path 1331 to block it.

A first stepped portion can be formed on an inner surface of one or both open end portions of the main flow path 1331, and a second stepped portion 1341 corresponding to the first stepped portion can be formed in the stopper 134.

The stopper 134 is inserted into both open end portions of the main flow path 1331.

In some examples, the first stepped portion and the second stepped portion contact each other. In addition, a sealing member 1342 such as an O-ring can be inserted between the first stepped portion and the second stepped portion.

In addition, the extension portion of the stopper 134 formed by the second stepped portion can be inserted and fixed into the inner hole of the main flow path 1331 formed by the first stepped portion.

The filter bracket 130 includes a first filter bracket 130a and a second filter bracket 130b connected to one side of the first filter bracket 130a, and the length of the filter bracket 130 can be adjusted according to the number of the filter 120.

In other words, the filter bracket 130 can be used as one, or can be used in plurality by extending two or more in the horizontal direction.

In addition, as described above, when the first filter bracket 130a and the second filter bracket 130b are connected, the clip 139 can be plugged in the connection portion between the first filter bracket 130a and the second filter bracket 130b.

The clip 139 can be provided to fix one end portion of the first filter bracket 130a and the other end portion of the second filter bracket 130b coupled to each other in a manner of simultaneously gripping each other.

In addition, as described above, when a plurality of filter brackets are connected, one end portion of the second filter bracket 130b is connected to one end portion of the first filter bracket 130a in such a way that the second filter bracket 130b is inserted thereinto, and thus as a result, the flow path of the first filter bracket 130a and the flow path of the second filter bracket 130b can be connected.

In addition, the filter bracket 130 forms an extension wall 135 extending downward, and the extension wall 135 is fixed to the main body of the water purifier.

The extension wall 135 can be provided in the form of a flat plate and can be fixed to the inner surface of the water purifier main body through various fastening member while in contact with the inner surface of the water purifier main body.

In the extension wall 135, a fastening groove 1352 having a concave shape toward the rear is formed at a position where the fastening member is fastened, and a fastening hole 1351 can be formed in the fastening groove 1352.

In addition, the filter bracket 130 includes a fixing member 136 which is rotatably installed on the filter bracket 130 to selectively fix the filter head 122 while rotating about the direction in which the filter bracket 130 extends.

One side of the fixing member 136 is open, and at least a portion thereof can be formed in an arc shape.

Both end portions of the fixing member 136 can be rotatably connected to both sides of the filter bracket 130.

The fixing member 136 can be rotated upward to release the fixation of the filter head 122 in a state where the filter head 122 is erected vertically.

In addition, the fixing member 136 can rotate forward to fix the filter head 122 at a position parallel to the horizontal direction.

The filter head 122 includes a side portion 1223 formed to be forwardly convex so that the movement is limited by the fixing member 136 while contacting at least a portion of the fixing member 136 in a state where the fixing member 136 is rotated forward.

In addition, at the lower end of the fixing member 136, a gripping portion 1363 extending outwardly is formed to facilitate gripping of the fixing member 136.

Therefore, the user can rotate the fixing member 136 by gripping the gripping portion 1363 protruding outward and extending along the lower circumference of the fixing member 136.

The fixing member 136 can have a semicircular shape in which at least a portion thereof is forwardly convex in a forwardly rotated state.

In addition, in one side of the first protrusion 1321a defining the first groove 1321 and the other side of the second protrusion 1322a defining the second groove 1322, shaft portions 1321b and 1322b extending outwardly are formed, respectively, and both end portions of the fixing member 136 are rotatably coupled to the shaft portions 1321b and 1322b.

Both end portions of the fixing member 136 can form concave shaft grooves 1364 on surfaces facing each other so that the shaft portions 1321b and 1322b are fitted thereinto.

In addition, stoppers 1365 protruding to limit the rotation of the fixing member 136 while contacting the filter bracket 130 in a state where the fixing member 136 rotates upward can be formed on both end portions of the fixing member 136.

In addition, extension ribs 1366 that are convex inward and extend downward can be formed on surfaces facing each other of both end portions of the fixing member 136.

The extension rib 1366 is formed lower than the shaft groove 1364.

The extension rib 1366 can push at least a portion of the filter head 122 forward when the fixing member 136 is rotated upward.

When the extension rib 1366 is formed as described above, the filter head 122 is pushed forward by only rotating the fixing member 136 upward, and the filter head 122 is pushed forward and the filter head 122 can be separated from the filter bracket 130.

In addition, the fixing member 136 can have an inclined or curved pressing portion 1367 formed on the inside of the front surface.

The pressing portion 1367 can push at least a portion of the filter head 122 backward when the fixing member 136 is rotated forward.

When the pressing portion 1367 is formed as described above, the filter head 122 is pushed backward only by rotating the fixing member 136 forward, and the filter head 122 can be coupled to the filter bracket 130.

In addition, a locking rib 1368 protruding outward can be additionally formed on an upper portion of the extension rib 1366.

At least a portion of the locking rib 1368 can be formed in a flat shape.

When the locking rib 1368 is formed, when the filter head 122 is coupled to the filter bracket 130 while rotating the fixing member 136 forward, the locking rib 1368 is locked to the filter head 122. In addition, the user can recognize this and rotate the fixing member 136 forward with a stronger force to securely couple the filter head 122 to the filter bracket 130. In addition, as the filter head 122 is coupled to the filter bracket 130 with a stronger force due to the configuration of the locking rib 1368, the gap between components is reduced.

In addition, a locking protrusion 1224 protruding forward is formed on the front surface of the filter head 122, and on the inner surface of the fixing member 136, in a state where the fixing member 136 is rotated forward, a locking groove 1361 into which the locking protrusion 1224 is fitted is formed.

In addition, a locking step 1362 protruding outward from the inner surface of the fixing member 136 can be formed at an upper end of the locking groove 1361.

At this time, the locking protrusion 1224 is fitted into the locking groove 1361, so that the fixing member 136 can more firmly fix the filter head 122, and the lower end of the locking step 1362 hangs over the upper end of the locking protrusion 1224, so that the rotation of the fixing member 136 can be restricted.

In addition, pressing protrusions 1227 protruding outward can be formed at both end portions of the filter head 122.

In addition, a pressing groove 138 open in a horizontal direction can be formed in the filter bracket 130 so that the pressing protrusion 1227 is fitted therein.

As described above, when the pressing protrusion 1227 is fitted into the pressing groove 138, the fastening force between the filter head 122 and the filter bracket 130 can be further improved.

In addition, the filter main body 121 includes a filter cap 123 coupled to the filter head 122 at an upper end, and a protrusion 1231 is formed on the filter cap 123, and an opening 1225 opened to check the protrusion 1231 from the outside is formed on the filter head 122.

The protrusion 1231 can form an inclined surface 1231a on one side or the other side surface.

One side of a rib 1226 that is elastically deformed and locked with one side surface of the protrusion 1231 is connected to one side of the opening 1225. The rib 1226 can have a convex shape toward the inside of the filter head 122.

Therefore, when the user fits the filter cap 123 into the filter head 122 in a state where the filter main body 121 and the filter cap 123 are coupled, the user can check a state where the filter cap 123 is coupled through the opening 1225, and while the rib 1226 presses the protrusion 1231, when one end portion of the rib 1226 (right end portion in FIG. 13) is locked to one end portion of the protrusion 1231 (left end portion in FIG. 13), the user can recognize that the filter cap 123 is properly coupled to the filter head 122.

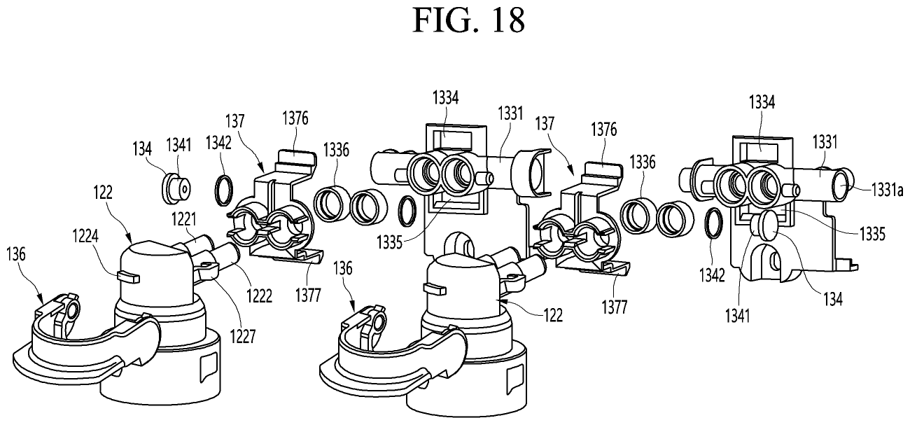

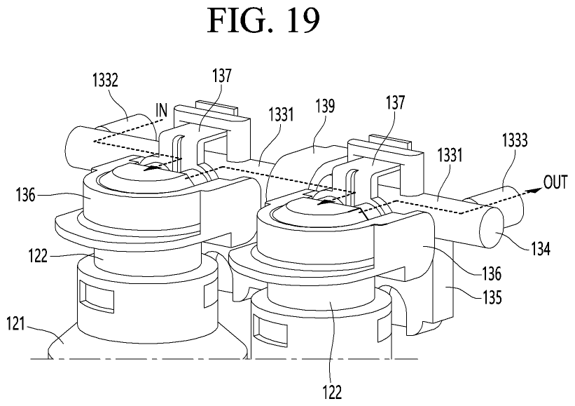

FIG. 17 is a perspective view illustrating a filter socket, FIG. 18 is an exploded perspective view illustrating a filter head and a filter bracket, and FIG. 19 is a view illustrating the flow path of water in the filter bracket.

In some implementations, referring to FIGS. 17 and 18, the filter bracket 130 can further include a filter socket 137. For example, the filter socket 137 can be disposed between the filter bracket 130 and the filter head 122. The filter socket 137 can form a third groove 1371 and a fourth groove 1372 at positions corresponding to the first groove 1321 and the second groove 1322 of the filter bracket 130, respectively.

In some examples, the filter socket 137 forms a first extension portion 1373 and a second extension portion 1374 protruding forward to define the third groove 1371 and the fourth groove 1372, respectively.

The first extension portion 1373 and the second extension portion 1374 can form a hollow cylindrical shape.

The first extension portion 1373 and the second extension portion 1374 can form a first opening portion 1373a and a second opening portion 1374a opened toward the outside on the outer surfaces, respectively.

The first opening portion 1373a and the second opening portion 1374a are open in a horizontal direction, and pressing protrusions 1227 protruding outward can be inserted into both end portions of the filter head 122.

A third opening portion 1375 can be formed between the first extension portion 1373 and the second extension portion 1374.

The third opening portion 1375 is formed so that the third groove 1371 and the fourth groove 1372 communicate with each other.

In addition, the filter socket 137 can further include a third extension portion and a fourth extension portion protruding rearward from the circumferences of the third groove 1371 and the fourth groove 1372, and the third extension portion and the fourth extension portion can be fitted into the first groove 1321 and the second groove 1322 of the filter bracket 130, respectively.

Accordingly, the third groove 1371 and the fourth groove 1372 of the filter socket 137 can communicate with the first groove 1321 and second groove 1322 of the filter bracket 130, respectively.

In addition, ring-shaped connecting members are disposed between the third groove 1371 and the fourth groove 1372 of the filter socket 137 and the first groove 1321 and second groove 1322 of the filter bracket 130, respectively, and the third groove 1371 and the fourth groove 1372 can be connected to the first groove 1321 and the second groove 1322 through the connecting member 1336, respectively.

The filter socket 137 can form an upper fastening portion 1376 extending rearwardly at the upper end and then extending toward the upper end.

In addition, the filter socket 137 can form a lower fastening portion 1377 extending rearward at the lower end and then extends toward the lower end.

In addition, the filter bracket 130 can have an upper fastening hole 1337 formed on the upper portion of the main flow path 1331 so that the upper fastening portion 1376 of the filter socket 137 is fitted. Further, the filter bracket 130 can form a lower fastening hole 1335 at the lower portion of the main flow path 1331 so that the lower fastening portion 1334 of the filter socket 137 is fitted.

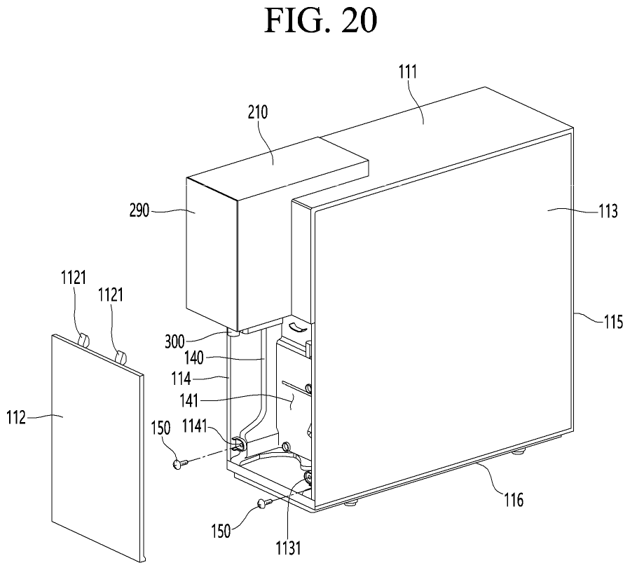

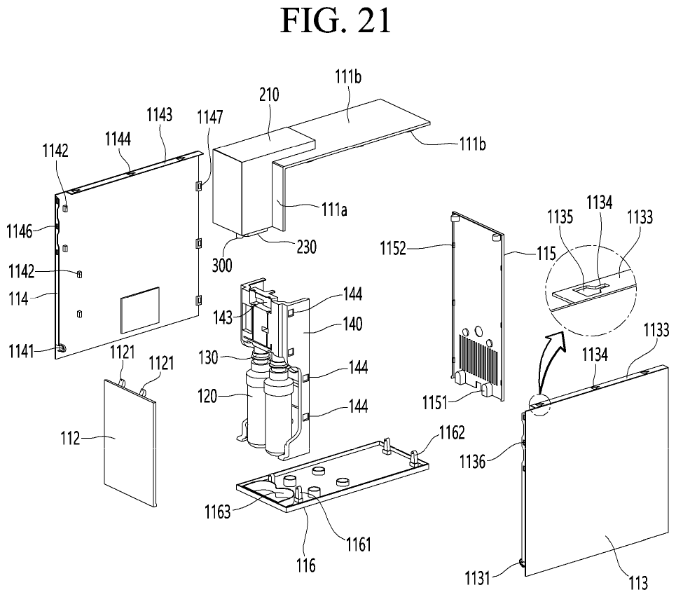

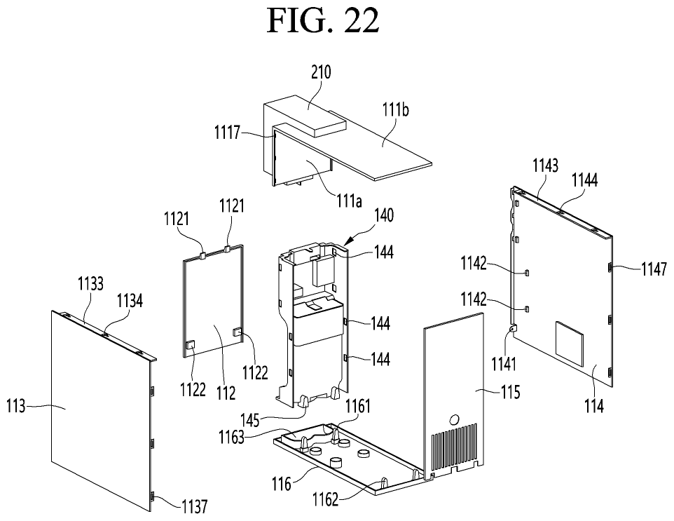

FIG. 20 is a view illustrating a state where filters are deleted in FIG. 6, FIG. 21 is a view from the front of the housing and the filter housing in a disassembled state, and FIG. 22 is a view from the rear of the housing and the filter housing in a disassembled state.

Referring to FIGS. 20 to 22, the water purifier can include a filter housing 140 that is disposed inside the water purifier main body 100. A filter accommodating groove 141 in which the filter 120 is accommodated is concave backward in the filter housing 140.

In addition, the filter bracket 130 is installed at an upper end of the filter accommodating groove 141, and a mounting groove 143 concave backward is formed at an upper end of the front surface of the filter housing 140, and a speaker or the like can be mounted in the mounting groove 143.

The filter accommodating groove 141 is disposed lower than the mounting groove 143.

In some examples, when the front panel 112 is separated from the water purifier main body 100, the filter accommodating groove 141 and the filter 120 accommodated in the filter accommodating groove 141 are exposed to the outside of the front.

Therefore, when replacing the filter 120, the front panel 112 can be opened and the filter 120 can be removed or installed.

In this case, the front panel 112 can be separably coupled to the filter housing 140. In other words, the front panel 112 is detachably coupled to the filter housing 140.

For example, the filter housing 140 forms open fixing holes on both sides of the upper surface of the filter accommodating groove 141.

The fixing hole can be formed long in the left and right direction.

Further, fixing protrusions 1121 extending upward are formed at upper ends of both sides of the front panel 112 to be inserted from the lower side to the upper side of the fixing hole.

The fixing protrusion 1121 can extend upward from an upper end of the rear surface of the front panel 112.

Accordingly, when the fixing protrusion 1121 is fitted into the fixing hole, the front panel 112 can be fixed to the filter housing 140.

In addition, when the fixing protrusion 1121 is separated from the fixing hole, the front panel 112 can be separated from the filter housing 140.

A lower end of the front panel 112 can be spaced apart from a bottom surface on which the water purifier main body 100 is placed. In addition, the front panel 112 can be separated by inserting a hand into the space spaced apart from the front panel 112 and the bottom surface.

In addition, the front panel 112 has first coupling portions 1122 formed at both lower ends of the rear surface facing the filter 120, and the filter housing 140 can form a second coupling portion 150 fixed to the first coupling portion 1122 at a position facing the first coupling portion 1122.

The first coupling portion 1122 and the second coupling portion 150 allow the front panel 112 to be fixed to the filter housing 140, which can be implemented in various ways to the extent that the fixation can be released.

For example, the first coupling portion is formed of a protrusion extending rearward from the lower end of the front panel 112, and the second coupling portion is formed at the lower end of the filter housing 140 and can be formed as a step or the like on which a groove into which the protrusion of the front panel is inserted or protrusion is seated.

As another example, the second coupling portion is formed at the lower end of the filter housing 140 and includes a protrusion extending toward the front panel, and the first coupling portion can be formed as a step or the like on which the groove into which the protrusion of the filter housing 140 is inserted or a protrusion is seated.

As another example, one of the first coupling portion 1122 and the second coupling portion 150 can be provided with a magnet, and the other one can be provided with a magnetic material attached to the magnet.

First, the first coupling portion 1122 can be provided as a magnet, and the second coupling portion 150 can be provided as a magnetic material.

In addition, the first coupling portion 1122 can be provided with a magnetic material, and the second coupling portion 150 can be provided with a magnet.

In addition, both the first coupling portion 1122 and the second coupling portion 150 can be provided as magnets, or both can be provided as magnetic materials.

As described above, when the first coupling portion 1122 and the second coupling portion 150 are provided with a magnet or a magnetic material, the lower end of the front panel 112 can be fixed while contacting the lower end of the filter housing 140.

In some examples, when the lower end of the front panel 112 is pulled forward, the lower end of the front panel 112 is separated from the filter housing 140 and the front panel 112 can be separated from the filter housing 140.

In addition, contact protrusions 1131 and 1141 contacting both end portions of the filter housing 140 are formed at lower ends of the first and second side panels 113 and 114, respectively.

A contact protrusion 1131 extending toward the second side panel 114 is formed at lower end of the first side panel 113, and contact protrusion extending toward the first side panel 113 is formed at the lower end of the second side panel 113.

In other words, the contact protrusions 1131 and 1141 extend in directions facing each other.

In addition, the contact protrusions 1131 and 1141 come into contact with the lower end of the front surface of the filter housing 140 and at least partially overlap the lower end of the front surface of the filter housing 140.

For example, the second coupling portion 150 can include a screw that is fastened from the front to the rear of the contact protrusions 1131 and 1141.

The second coupling portion 150 can fix the first and second side panels 113 and 114 to the filter housing 140 while being fastened from the front to the rear of the contact protrusions 1131 and 1141.

In addition, a first protrusion 1161 convexly protruding upward is formed on the base 116 at a position where the filter housing 140 is disposed, and a first groove 145 concave upwardly into which the first protrusion 1161 is fitted is formed on the filter housing 140.

The first protrusion 1161 can be formed at upper ends of both sides of the base 116. The first protrusion 1161 can be gradually narrowed in width from the lower end to the upper end to form an inclined surface on the outer surface.

In some examples, like the first protrusion 1161, the first groove 145 can be formed at lower ends of both sides of the filter housing 140. In addition, the first groove 145 can be formed such that the width thereof gradually narrows from the lower end to the upper end to form an inclined surface on the inner surface.

As described above, when the first protrusion 1161 and the first groove 145 are formed, while the filter housing 140 is placed on the base 116, when the first protrusion 1161 is inserted into the first groove 145, the filter housing 140 can be fixed to the base 116. Then, the filter housing 140 can be disposed in position.

In addition, a filter groove 1163 can be formed concave downward in the base 116 so that the lower end of the filter 120 is accommodated at the front end of the first protrusion 1161.

The filter groove 1163 can have a shape of a container with a concave lower side.

The surface forming the filter groove 1163 is blocked so that water can be contained therein.

A plurality of filter grooves 1163 can be provided according to the number of filters 120.

When the plurality of filter grooves 1163 are provided, intermediate protrusions 1164 can be formed between the filter grooves 1163 to partition each of the filter grooves 1163.

In the case of the intermediate protrusion 1164, it can protrude forward from a rear surface between the filter grooves 1163.

In addition, in the case of the intermediate protrusion 1164, the intermediate protrusion can protrude rearward from the front surface between the filter grooves 1163.

A lower end of the filter 120 can be inserted into and fixed to the filter groove 1163.

At least a portion of the surface forming the filter groove 1163 can be formed as a curved surface 1168 to correspond to the outer surface of the filter 120.

In particular, since the lower end of the filter 120 is fixed, separation of the filter 120 can be prevented.

In addition, when leakage occurs in the filter bracket 130 and the filter 120, leaked water can be collected in the filter groove 163. In some examples, leaked water can be drained or emptied by the user.

If the filter groove 163 is not provided, when water leakage occurs in the filter bracket 130 and the filter 120, there is a problem in that leaked water leaks out to the floor.

In addition, an upper end of the front surface of the water purifier main body 100 is covered by a first cover portion 111a extending downward from the front end of the top cover 111, and the front panel 112 covers a space between the lower end of the first cover portion 111a and the front end of the base 116.

In addition, the filter accommodating groove 141 can be formed at a position facing the front panel 112. Accordingly, when the front panel 112 is separated, the filter 120 installed in the filter accommodating groove 141 is exposed to the outside, and the filter 120 can be separated or replaced.

In addition, a second protrusion 1162 convexly protruding upward is formed on the base 116 at a position where the rear panel 115 is disposed, and a second groove 1151 concave upward to which the second protrusion 1162 is fitted is formed on the rear panel 115.

The second protrusion 1162 can be formed at upper ends of both sides of the base 116. The width of the second protrusion 1162 can be gradually narrowed from the lower end to the upper end to form an inclined surface on the outer surface.

In some examples, like the second protrusion 1162, the second groove 1151 can be formed at lower ends of both sides of the front surface of the rear panel 115. In addition, the width of the second groove 1151 is gradually narrowed from the lower end to the upper end, so that an inclined surface can be formed on the inner surface.

As described above, when the second protrusion 1162 and the second groove 1151 are formed, when the second protrusion 1162 is inserted into the second groove 1151 while the rear panel 115 is placed on the base 116, the rear panel 115 can be fixed to the base 116. Then, the rear panel 115 can be disposed in position.

In addition, horizontal extension portions 1133 and 1143 extending toward each other can be formed at upper ends of the first and second side panels 113 and 114, respectively. The horizontal extension portions 1133 and 1143 can be formed by bending upper ends of the first and second side panels 113 and 114, respectively.

In addition, a plurality of coupling holes 1134 and 1144 are formed in the horizontal extension portions 1133 and 1143.

In addition, coupling protrusions 1116 which extend downward to be inserted into and fixed to the coupling holes 1134 and 1144 can be formed on both sides of the bottom surface of the top cover 111.

As described above, when the coupling holes 1134 and 1144 are formed in the first and second side panels 113 and 114 and the coupling protrusion 1116 is formed on the bottom surface of the top cover 111, the top cover 111 can be fixed to the first and second side panels 113 and 114 by inserting the coupling protrusion 1116 into the coupling hole 1134, 1144.

In addition, the coupling holes 1134 and 1144 can include an extension portion 1135 having an extended width at the front end. The extension portion 1135 can be larger than the coupling protrusion 1116.

Accordingly, the coupling protrusion 1116 can be more easily inserted into the coupling holes 1134 and 1144 through the extension portion 1135.

For example, when the top cover 111 is seated on the upper side of the horizontal extension portions 1133 and 1143, the coupling protrusion 1116 is inserted into the extension portion 1135, and when the top cover 111 is pushed backward, the coupling protrusion 1116 can be fixed while being inserted into the coupling holes 1134 and 1144.

In addition, the coupling protrusion 1116 can be formed in a shape that first extends downward from the bottom surface of the top cover and then secondarily extends rearward.

In other words, the coupling protrusion 1116 can have a shape bent backward.

In the above case, the top cover 111 is seated on the upper side of the horizontal extension portions 1133 and 1143, when the coupling protrusion 1116 is fitted into the extension portion 1135, and then the top cover 111 is pushed backward, as the coupling protrusion 1116 is inserted into the coupling holes 1134 and 1144, the rearwardly extending portion of the coupling protrusion 1116 contacts the bottom surface of the horizontal extension portions 1133 and 1143, and as a result, the horizontal extension portion 1133 and 1143 are fitted between the top cover 111 and the rearwardly extending portion of the coupling protrusion 1116, so that the top cover 111 and the first and second side panels 113 and 114 can be securely fixed.

At this time, when the top cover 111 is pulled forward and then the top cover 111 is lifted upward in a state where the coupling protrusion 1116 is positioned on the extension portion 1135, the top cover 111 can be separated from the first and second side panels 113 and 114.

In addition, the first and second side panels 113 and 114 form at least one extension protrusion 1142 extending toward the filter housing 140 at a position facing the side surface of the filter housing 140, and a fixing hole 144 opened to insert the extension protrusion 1142 can be formed on a side surface of the filter housing 140.

The fixing hole 144 can be formed on both side surfaces of the filter housing 140.

In addition, the first side panel 113 and the second side panel 114 can be formed symmetrically based on an imaginary line in the front and rear direction. In other words, the extension protrusion 1142, the horizontal extension portions 1133 and 1143, the coupling holes 1134 and 1144, and the extension portion 1135 can be symmetrically formed on the first side panel 113 and the second side panel 114 based on an imaginary line in the front and rear direction.

As described above, when the extension protrusions 1142 are formed on the first and second side panels 113 and 114 and the fixing hole 144 is formed on the filter housing 140, the first and second side panels 113 and 114 and the filter housing 140 can be combined with each other.

In addition, first connection holes 1147 are formed at rear ends of the first and second side panels 113 and 114, and first connection protrusions 1152 which are fitted into the first connection holes 1147 are formed on both end portions of the rear panel 115. so that the first and second side panels 113 and 114 and the rear panel 115 can be coupled.

In addition, second connection holes 1146 are formed at the front ends of the first and second side panels 113 and 114, and second connecting protrusions 1117 which are fitted into the second connection holes 1146 are formed at both end portions of the first cover portion 111a so that the first and second side panels 113 and 114 and the first cover portion 111a can be coupled.

In addition, auxiliary grooves can be additionally formed at the rear end of the first cover portion 111a, into which protrusions formed to protrude upward from upper ends of both sides of the rear panel 115 are inserted.

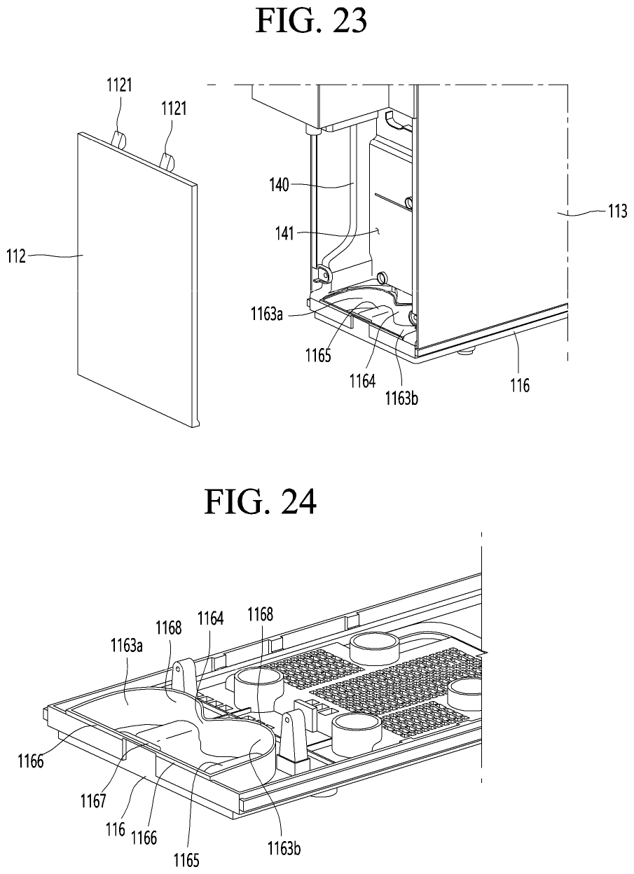

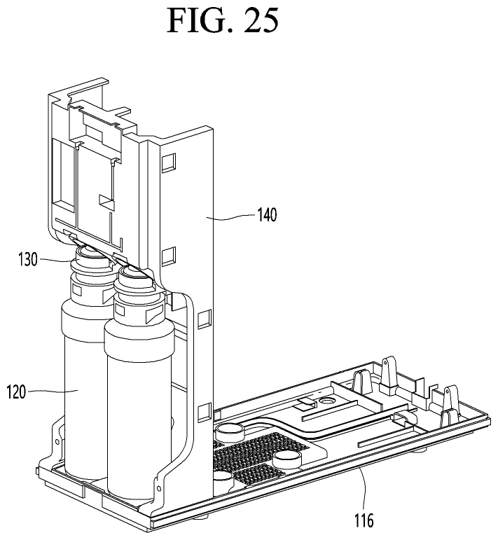

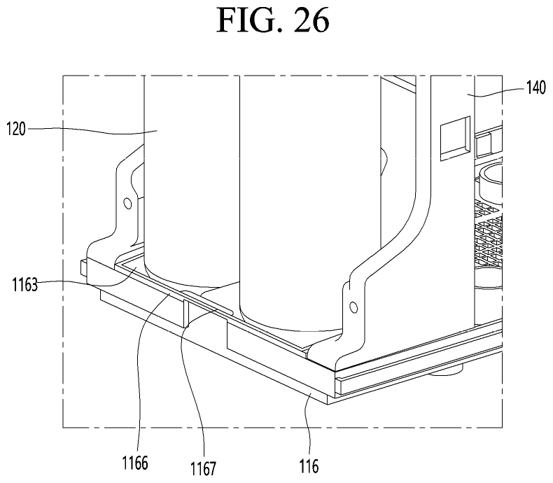

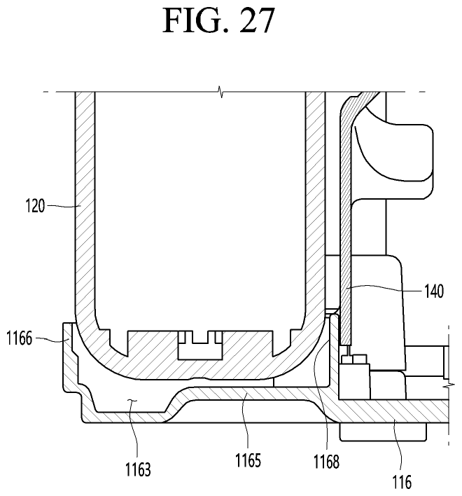

FIG. 23 is an enlarged view illustrating a portion of FIG. 20, FIG. 24 is an enlarged view illustrating the front end of the base, FIG. 25 is a view illustrating a state where the filter housing and the base are assembled, FIG. 26 is an enlarged view illustrating a portion of FIG. 25, and FIG. 27 is a longitudinal sectional view of FIG. 26.

Referring to FIGS. 23 to 27, a plurality of filter grooves 1163 can be provided.

For example, when two filters 120 are provided, the filter groove 1163 can include a first filter groove 1163a and a second filter groove 1163b.

The first filter groove 1163a and the second filter groove 1163b can be provided side by side on both sides.

The first filter groove 1163a and the second filter groove 1163b can communicate with each other or be blocked from each other.

An intermediate wall can be formed between the first filter groove 1163a and the second filter groove 1163b to block the first filter groove 1163a and the second filter groove 1163b.

An intermediate protrusion 1164 protruding forward from the center can be formed on a rear surface of inner surfaces defining the first filter groove 1163a and the second filter groove 163b.

The intermediate protrusion 1164 can partition the first filter groove 1163a and the second filter groove 1163b.

In some examples, the intermediate protrusion 1164 can support the filter 120 while contacting the lower end of the filter 120. A surface of the intermediate protrusion 1164 in contact with the lower end of the filter 120 can be formed as a curved surface.

In addition, separation protrusions 1165 protruding upward can be formed on bottom surfaces of the first filter groove 1163a and the second filter groove 1163b, respectively.

The separation protrusion 1165 supports the lower end of the filter 120 so that the lower end of the filter 120 can be spaced apart from the bottom surfaces of the first filter groove 1163a and the second filter groove 1163b.

Due to the configuration of the separation protrusion 1165, the filter 120 may not come into contact with water even when the first filter groove 1163a and the second filter groove 1163b are filled with leaking water.

The separation protrusion 1165 can extend forward from rear ends of the first filter groove 1163a and the second filter groove 1163b.

In addition, the base 116 can form a front rib 1166 extending upward at the front end. For example, the front rib 1166 can protrude upward from the base 116. The front rib 1166 can include a front surface defining the filter groove 1163. The front rib 1166 can support a lower end of the filter 120. The front rib 1166 can be provided as a plane. The surface of the front rib 1166 facing the filter 120 can be a curved surface so that it is concave forward.

In some cases, the front rib 1166 can be provided separately regardless of whether or not the filter groove 1163 is formed. In other words, the base 116 can have the front rib 1166 formed at the front end without forming the filter groove 1163.

The lower end of the filter 120 can be contacted and supported by the front rib 1166, and the filter can be maintained in an upright state without falling over.

In particular, when the fixing member 136 is rotated upward to separate the filter 120, the filter head 122 is pushed forward by the extension rib 1366, and the front rib 1166 can prevent the filter 120 from falling forward.

In detail, the extension rib 1366 can push at least a portion of the filter head 122 forward when the fixing member 136 is rotated upward.

When the extension rib 1366 is formed as described above, the filter head 122 is pushed forward by only rotating the fixing member 136 upward, and the filter head 122 can be separated from the filter bracket 130.

In some cases, there is a risk that the filter 120 falls forward.

As described above, the extension rib 1366 can contact and support the lower end of the filter 120 so that the filter 120 does not fall forward.

In some examples, the filter groove 1163 can also fix the lower end of the filter 120 so that the filter 120 does not fall forward.

In addition, the extension rib 1366 can form a support protrusion 1167 protruding rearward from the center.

When the support protrusion 1167 is formed on the extension rib 1366, the filter 120 can be more securely fixed when the plurality of filters 120 are mounted.

In general, the filter 120 is provided in a cylindrical shape.

In addition, when the extension rib 1366 is formed in a plane, the filter 120 and the extension rib 1366 are supported by contacting only one place.

However, when the support protrusion 1167 is formed, the filter 120 is supported by contacting the extension rib 1366 and the support protrusion 1167, respectively. Therefore, while the filter 120 is supported in contact with two places, the filter 120 can be fixed more reliably.

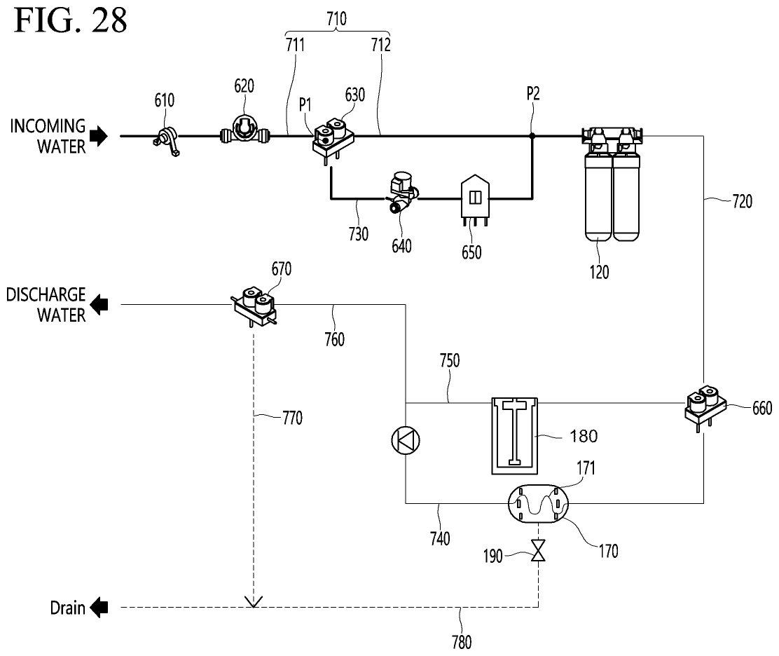

FIG. 28 is a water piping diagram of a water purifier.

Referring to FIG. 28, the water purifier discharges hot water and purified water, but the hot water and purified water are discharged through one flow path.

First, water supplied from a water supply source is guided toward the filter 120 through the water supply flow path 710.

Then, purified water that has passed through the filter 120 flows through the intermediate flow path 720.

The intermediate flow path 720 has one side connected to the outlet side of the filter 120 and the other side connected to the inlet side of the hot water module 170, so that the water passing through the filter 120 is guided toward of the hot water module 170.

In addition, purified water or hot water that has passed through the hot water module 170 is supplied toward the water outlet nozzle 300 through the hot water flow path 740.

The hot water flow path 740 is connected to the water outlet nozzle 300 through the water outlet flow path 760. Accordingly, water passing through the hot water module 170 and the hot water flow path 740 passes through the water outlet flow path 760 and then is discharged to the water outlet nozzle 300.

When power is supplied to the hot water module 170 and purified water is heated in the hot water module 170, hot water is discharged through the water outlet nozzle 300.

In addition, when the power to the hot water module 170 is cut off, purified water passing through the hot water module 170 is not heated and is discharged through the water outlet nozzle 300 as purified water.

In some implementations, hot water and purified water are discharged through one flow path.

In the case of hot water and purified water, both hot water and purified water pass through the water supply flow path 710, the filter 120, the intermediate flow path 720, the hot water module 170, the hot water flow path 740, and the water outlet flow path 760, and discharge to the water outlet nozzle 300.

The difference is whether the hot water module 170 is operating. When purified water is discharged, the controller switches the hot water module 170 to an off state so that the hot water module 170 does not operate and the purified water passing through the hot water module 170 flows to the water outlet flow path 760 in a state of purified water. In some examples, when hot water is discharged, the controller switches the hot water module 170 to an on state, the hot water module 170 operates, and purified water passing through the hot water module 170 is heated as hot water. For example, the controller can include an electric circuit, one or more processors, or the like.

The hot water module 170 includes a hot water tank. In addition, a heating flow path 171 through which purified water passing through the filter 120 passes is formed in the hot water tank, and when hot water is discharged, the purified water passing through the heating flow path 171 is heated as hot water. In some examples, when purified water is discharged, the purified water that has passed through the heating flow path 171 maintains a state of the purified water without a change in temperature.

Referring to FIG. 28, a hot water flow path 740 and a water outlet flow path 760 are provided to guide purified water or hot water that has passed through the hot water module 170 toward the water outlet nozzle 300. In other words, purified water or hot water discharged from the hot water module 170 is discharged toward the water outlet nozzle 300 via the hot water flow path 740 and the water outlet flow path 760.

The controller controls the operation of the hot water module 170.

When purified water is discharged, the controller turns off the heating source of the hot water module 170, and the purified water discharged from the hot water module 170 passes through the hot water flow path 740 and the water outlet flow path 760 to discharge to the water outlet nozzle 300. In other words, when purified water is discharged, the heating source of the hot water module 170 is turned off, so that purified water is not heated when passing through the heating flow path 171 of the hot water module 170, and can be discharged in the state of purified water. In addition, purified water can be supplied to the water outlet nozzle 300 via the hot water flow path 740 and the water outlet flow path 760.

In addition, when hot water is discharged, the controller turns on the heating source of the hot water module 170, and the hot water discharged from the hot water module 170 passes through the hot water flow path 740 and the water outlet flow path 760. to discharge to the water outlet nozzle 300. In other words, when the heating source of the hot water module 170 is turned on, purified water is heated when passing through the heating flow path 171 of the hot water module 170 and discharged as hot water. In addition, the hot water discharged from the hot water module 170 can be supplied to the water outlet nozzle 300 via the hot water flow path 740 and the water outlet flow path 760.

The water purifier can further include an auxiliary flow path 730 joining to the second point P2 of the water supply flow path 710 located at a rear end of the first point P1 based on the flow direction of water, after branching at the first point P1 of the water supply flow path 710. In some examples, a flow rate control valve 640 can be installed in the auxiliary flow path 730. The flow rate control valve 640 can control the flow rate of water passing through the auxiliary flow path 730.

For example, the flow rate control valve 640 can lower the flow rate of water passing through the auxiliary flow path 730.

The controller is connected to the flow rate control valve 640 and controls the flow rate control valve 640. In detail, the controller can open or block the flow rate control valve 640. In addition, the controller can adjust the degree of opening of the flow rate control valve 640, and as a result, the flow rate of water passing through the auxiliary flow path 730 can be adjusted.

In addition, a temperature sensor for detecting the temperature of water passing through the auxiliary flow path 730 can be installed in the auxiliary flow path 730.

The temperature sensor can be integrally installed in the flow rate control valve 640.

For reference, the temperature sensor can be installed in at least one of various water supply flow paths 710, intermediate flow paths 720, hot water flow paths 740, and water outlet flow paths 760. In addition, the temperature sensor can be installed in the hot water module 170 or can be installed in a water outlet valve 670 to be described later.

In addition, the controller can be connected to a temperature sensor to receive water temperature information detected by the temperature sensor. In addition, the output of the hot water module 170 or the auxiliary heater 650 described below can be controlled by utilizing the input temperature information.

In addition, a water supply valve 630 can be installed at the first point P1.

The water supply valve 630 can control the flow of water flowing from the water supply flow path 710 to the auxiliary flow path 730.

In addition, the controller can control the operation of the water supply valve 630.

For example, the water supply valve 630 can have one inlet and two outlets. In some examples, an inlet of the water supply valve 630 can be connected to the water supply flow path 710, one of the two outlets can be connected to the water supply flow path 710 again, and the other can be connected to the auxiliary flow path 730.

The controller can open and close the inlet of the water supply valve 630 and open and close the outlet of the water supply valve 630. The controller can select and open one of the outlets of the water supply valve 630 and block the other one. The controller can open all outlets of the water supply valve 630 or can block all outlets of the water supply valve 630.

Accordingly, the water introduced into the water supply valve 630 can be delivered to the water supply flow path 710 or the auxiliary flow path 730.

The water supply flow path 710 can include a first water supply flow path 711 for guiding water toward the water supply valve 630 based on the water supply valve 630, and a second water supply flow path 712 for guiding water discharged from the water supply valve 630 toward the filter 120.

For example, the water introduced into the water supply valve 630 through the first water supply flow path 711 does not flow in the direction of the auxiliary flow path 730 and can flow only through the second water supply flow path 712.

As another example, water introduced into the water supply valve 630 through the first water supply flow path 711 can flow only in the direction of the auxiliary flow path 730 and not flow into the second water supply flow path 712.

As another example, the water introduced into the water supply valve 630 through the first water supply flow path 711 can partially flow in the direction of the auxiliary flow path 730 and also partially flow in the direction of the second water supply flow path 712.

When hot water is discharged, the controller can control the water supply valve 630 so that the water introduced through the first water supply flow path 711 passes through the auxiliary flow path 730. In some cases, the water introduced into the water supply valve 630 is not discharged toward the second water supply flow path 712, but is discharged only toward the auxiliary flow path 730.

In addition, the water passing through the auxiliary flow path 730 can be supplied to the filter 120 after being joined to the second water supply flow path 712 at the second point P2.

In some examples, when purified water is discharged, the controller can control the water supply valve 630 so that the water introduced through the first water supply flow path 711 flows only through the second water supply flow path 712.

In some cases, the water introduced into the water supply valve 630 is not discharged toward of the auxiliary flow path 730, but is discharged only toward the second water supply flow path 712.

In some examples, the water discharged through the second water supply flow path 712 can be supplied to the filter 120.

In general, in the case of purified water, after passing through the filter 120, the purified water is supplied to the water outlet nozzle 300 through a flow path. Therefore, there is no need to adjust the flow rate of water passing through the flow path, and the higher the flow rate, the better.

However, in the case of hot water, after passing through the filter 120, it is heated as hot water and then supplied to the water outlet nozzle 300. Therefore, in order to increase the hot water temperature, the flow rate of water introduced into the hot water module 170 can be lower than that of purified water.

In this situation, when a flow control valve is installed in the water supply flow path 710 for supplying water to the filter 120 and the flow rate supplied to the filter 120 is adjusted low, the temperature of the hot water is increased, so that the hot water condition can be satisfied. However, even when purified water is discharged, there is also a problem that the flow rate of purified water is also reduced due to the lowly adjusted flow rate.

In some implementations, the water purifier supplies water introduced through the first water supply flow path 711 to the filter 120 through the second water supply flow path 712 when purified water is discharged. Since the flow rate control valve is not installed in the second water supply flow path 712, a situation in which the flow rate of purified water is lowered is prevented and the condition of the flow rate of purified water can be satisfied.

In some implementations, when hot water is discharged, water introduced through the first water supply flow path 711 is supplied to the filter 120 through the auxiliary flow path 730. A flow rate control valve 640 is installed in the auxiliary flow path 730, and the flow rate lowered by the flow rate control valve 640 flows into the filter 120, and the flow rate supplied to the hot water module 170 is lowered, the hot water temperature can be increased, and the hot water temperature condition can be satisfied.

In some implementations, the path of water flowing from the water supply flow path 710 to the filter 120 is divided into two branches so that water flows only through the water supply flow path 710 when purified water is discharged so that the flow rate does not decrease, and when hot water is discharged In this case, the water in the water supply flow path 710 flows into the auxiliary flow path 730 to lower the flow rate, thereby satisfying the temperature condition of the hot water.

In some examples, purified water discharged from the filter 120 flows toward the hot water module 170 through the intermediate flow path 720.

Then, the water introduced into the hot water module 170 is heated and discharged as hot water, or is not heated and discharged as purified water to flow through the hot water flow path 740.

Hot water or purified water flowing through the hot water flow path 740 flows through the water outlet flow path 760 and then is supplied to the outside of the water purifier through the water outlet nozzle 300.

One side of the water outlet flow path 760 is connected to the hot water flow path 740 and the other side thereof is connected to the water outlet nozzle 300.

In addition, a water outlet valve 670 can be installed in the water outlet flow path 760 to control the flow of water flowing toward the water outlet nozzle 300.

The controller can control the operation of the water outlet valve 670.

In detail, the controller can control the water outlet valve 670 to open when purified water, hot water, or cold water is discharged, and can control the water outlet valve 670 to be blocked in a standby state where water is not discharged.

In some examples, after hot water is discharged, the hot water module 170 is in a heated state, and the hot water flow path 740, the hot water module 170, and the water outlet flow path 760 are also filled with hot water.

In this situation, when the user discharges purified water, a problem arises in that the hot water in the hot water flow path 740 or the hot water module 170 is discharged through the water outlet nozzle 300 before the purified water is discharged.

Therefore, hot water (residual water) remaining in the hot water flow path 740, the hot water module 170, and the water outlet flow path 760 can be drained after hot water is discharged and before purified water is discharged.

In some implementations, the water purifier includes a drain flow path 770. For example, the water outlet valve 670 is provided as a 3-way valve, and a drain flow path 770 can be connected to the water outlet valve 670. In some examples, the water introduced into the water outlet valve 670 can flow toward the water outlet nozzle 300 and can flow into the drain flow path 770.

The water outlet valve 670 can have one inlet and two outlets. In some examples, the inlet of the water outlet valve 670 is connected to the water outlet flow path 760 extending toward the hot water channel 740. In some examples, one of the two outlets is connected to the water outlet flow path 760 extending toward the water outlet nozzle 300, and the other outlet is connected to the drain flow path 770.

The controller can open and close the inlet of the water outlet valve 670 and open and close the outlet of the water outlet valve 670. The controller can select and open one of the outlets of the water outlet valve 670 and block the other one. The controller can open all outlets of the water outlet valve 670 or can block all outlets of the water outlet valve 670.

Therefore, the water introduced into the water outlet valve 670 can be discharged through the water outlet flow path 760 extending toward the water outlet nozzle 300 and discharged into the water outlet nozzle 300 or can be discharged through the drain flow path 770.

For example, when hot water is discharged, the water outlet valve 670 can be opened to discharge water into the water outlet flow path 760 extending toward the water outlet nozzle 300.

As another example, when the hot water discharge ends, the outlet connected to the drain flow path 770 of the water outlet valve 670 is opened, and the residual water in the hot water flow path 740, the water outlet flow path 760, or the hot water module 170 can be drained.

As described above, when the drain proceeds after the hot water is discharged, the hot water flow path 740, the water outlet flow path 760, or the hot water module 170 is filled with purified water or becomes empty.

Therefore, it is possible to prevent a problem in which the temperature of purified water increases due to high-temperature residual water when purified water is discharged after hot water is discharged.

If purified water is discharged after hot water is discharged and in a state where the drain is not in progress, even if the hot water module 170 is turned off, since the residual water having a high temperature remains in the hot water flow path 740, the water outlet flow path 760, or the hot water module 170, a problem arises in that hot water is discharged through the water outlet nozzle 300.

For reference, the drain can proceed until residual water in the hot water tank is discharged.

In some implementations, when the discharge of the hot water is ended, the drain can proceed regardless of whether purified water is discharged or not.

In other words, when hot water is discharged, the hot water module 170 operates, and the outlet of the water outlet valve 670 toward the water outlet nozzle 300 is opened.

In addition, when the hot water discharge is finished, the hot water module 170 stops working, and the outlet of the water outlet valve 670 toward the drain flow path 770 is opened, so that the hot water in the hot water flow path 740 or the hot water module 170 is drained through the drain flow path 770.

In addition, when the preset drain time elapses, the outlet of the water outlet valve 670 toward the drain flow path 770 is blocked.

In some implementations, when hot water discharge is finished and purified water is being discharged, after hot water is discharged, the elapsed time can be checked, and then the drain can be selectively performed according to the elapsed time.

In some implementations, when the hot water discharge is finished and the purified water is discharged, the residual water temperature of the hot water flow path 740, the water outlet flow path 760, the hot water module 170, or the water outlet valve 670 is checked, and the drain can be selectively performed according to the checked temperature.

In addition, the water purifier can have a function of discharging cold water.

To this end, the water purifier can further include a cold water flow path 750 having one side branched from the intermediate flow path 720 and the other side joining the water outlet flow path 760, and a cold water module 180 installed in the cold water flow path 750 and configured to cool purified water passing through the cold water flow path 750 with cold water.

In addition, in the intermediate flow path 720, a cold and hot water valve 660 can be installed at a branch point of the cold water flow path 750.

The controller controls the operation of the cold and hot water valve 660.

For example, when discharging hot water or discharging purified water, the controller can control the cold and hot water valve 660 to be opened toward the hot water module 170.

As another example, when cold water is discharged, the controller can control the cold and hot water valve 660 to open toward the cold water flow path 750.

The cold and hot water valve 660 can have one inlet and two outlets. And, the inlet of the cold and hot water valve 660 is connected to the intermediate flow path 720 extending toward the filter 120. In some examples, one of the two outlets is connected to the intermediate flow path 720 extending toward the hot water module 170, and the other is connected to the cold water flow path 750.

The controller can open and close the inlet of the cold and hot water valve 660 and open and close the outlet of the cold and hot water valve 660. The controller can select and open one of the outlets of the cold and hot water valve 660 and block the other one thereof. The controller can open all outlets of the cold and hot water valve 660 or can block all outlets of the water outlet valve 670.

Therefore, the water introduced into the cold and hot water valve 660 can be discharged through the intermediate flow path 720 extending toward the hot water module 170 and supplied to the hot water module 170 or discharged through the cold water flow path 750.

As a modified example, after hot water is discharged, hot water is in a heated state, and the hot water flow path 740, the hot water module 170, and the water outlet flow path 760 are also filled with hot water.

In this situation, when the user discharges purified water, a problem arises in that the hot water in the hot water flow path 740 or the hot water module 170 is discharged through the water outlet nozzle 300 before the purified water is discharged.

The controller can control the temperature of water discharged through the water outlet nozzle 300 to be low through cold water.

In some implementations, when purified water is discharged within a predetermined reference time after hot water is discharged, the controller controls the cold and hot water valve 660 to open the outlet toward the intermediate passage 720 connected to the hot water module 170 and also the outlet toward the cold water flow path 750.

Here, the reference time can be set in various ways. For example, the reference time can be set to 60 minutes.

In addition, after hot water is discharged, before the reference time elapses, and when purified water is discharged, the controller opens both outlets of the cold and hot water valve 660 at the same time, but the outlet toward the cold water flow path 750 is open for the first time, and then controlled to be blocked, and the outlet toward the intermediate flow path 720 connected to the hot water module 170 is controlled to be open for a second time longer than the first time.

Here, the first time and the second time can be set in various ways. For example, the first time can be set to 3 seconds.

In addition, the water discharged through the cold water flow path 750 and the hot water flow path 740 can be joined at the water outlet flow path 760 and then discharged through the water outlet nozzle 300.

In some implementations, when the hot water discharge is finished and the purified water is being discharged, after the hot water is discharged, the elapsed time can be checked, and a portion of the cold water can be selectively joined to the residual water according to the elapsed time.

In some implementations, when hot water discharge is finished and purified water is being discharged, the residual water temperature of the hot water flow path 740 or the water outlet flow path 760 or the hot water module 170 or the water outlet valve 670 is checked, and depending on the checked temperature, a portion of the cold water can be selectively joined to the residual water.

According to this, when purified water is discharged through the hot water flow path, the problem of hot water or lukewarm water initially being discharged due to residual hot water when purified water is discharged can be solved.

In the water supply flow path 710, at least one of a pressure reducing valve 610 for adjusting the water pressure of water introduced from a water supply source or a flow sensor 620 for checking the flow rate of water passing through the water supply flow path 710 can be installed.

For example, a pressure reducing valve 610 and a flow sensor 620 can be sequentially installed in the first water supply flow path 711 based on the flow direction of water.

In some examples, the controller can be connected to the flow sensor 620 and receive flow rate information sensed by the flow sensor 620. In addition, the output of the hot water module 170 or the auxiliary heater 650 to be described below can be controlled by utilizing the input flow rate information.

The water purifier has a hot water sterilization function.

An auxiliary heater 650 for heating water flowing through the auxiliary flow path 730 can be installed in the auxiliary flow path 730.

The auxiliary heater 650 can be formed behind the flow rate control valve 640 based on the flow direction of water.

In addition, the controller controls the overall operation of the auxiliary heater 650.

During hot water sterilization, the controller operates the auxiliary heater 650, and the hot water module 170 and the cold water module 180 stop operating.

Then, hot water heated while passing through the auxiliary heater 650 passes through the filter 120 and then flows in the direction of the water outlet nozzle 300.

As described above, when the auxiliary heater 650 operates, the auxiliary flow path 730 in which the auxiliary heater 650 is installed, the filter 120, the intermediate flow path 720, the hot water flow path 740, the cold water flow path 750, and the water outlet flow path 760 can be sterilized by hot water.

In addition, the controller controls the water supply valve 630 so that water in the first water supply flow path 711 flows to the auxiliary flow path 730 during hot water sterilization.

In addition, after being discharged from the filter 120, the controller can control the cold and hot water valve 660 so that water flowing through the intermediate flow path 720 flows toward the cold water flow path 750 or the hot water flow path 740.

For example, after being discharged from the filter 120, the controller can control the cold and hot water valve 660 so that water flowing through the intermediate flow path 720 flows toward the cold water flow path 750.

As another example, after being discharged from the filter 120, the controller can control the cold and hot water valve 660 so that the water flowing through the intermediate flow path 720 flows toward the hot water module 170 and the hot water flow path 740.

As another example, after being discharged from the filter 120, the controller can control the cold and hot water valve 660 so that the water flowing through the intermediate flow path 720 flows toward the cold water flow path 750 and the hot water flow path 740.

In some cases, after being discharged from the filter 120, the water flowing through the intermediate flow path 720 can simultaneously flow toward the cold water flow path 750 and the hot water flow path 740.

In addition, after being discharged from the filter 120, the water flowing through the intermediate flow path 720 sequentially first flows toward the cold water flow path 750, then flows toward the hot water flow path 740, or flows toward the hot water flow path 740 first, then flows toward the cold water flow path 750.

In addition, the controller can control the water outlet valve 670 so that water in the water outlet flow path 760 flows toward the water outlet nozzle 300 or the drain flow path 770 during hot water sterilization.

For example, the controller can control the water outlet valve 670 so that water introduced into the water outlet valve 670 through the water outlet flow path 760 flows toward the water outlet nozzle 300.

As another example, the controller can control the water outlet valve 670 so that water introduced into the water outlet valve 670 through the water outlet flow path 760 flows toward the drain flow path 770.

As another example, the controller can control the water outlet valve 670 so that water introduced into the water outlet valve 670 through the water outlet flow path 760 flows toward the water outlet nozzle 300 and also flows toward the drain flow path 770.

In some cases, the water introduced into the water outlet valve 670 through the water outlet flow path 760 can simultaneously flow toward the water outlet nozzle 300 and the drain flow path 770.

In addition, water introduced into the water outlet valve 670 through the water outlet flow path 760 sequentially first flows toward the water outlet nozzle 300 and then can flow toward the drain flow path 770, or first flows toward the drain flow path 770 and then can flow toward the water outlet nozzle 300.

In addition, the water purifier 10 can further include a steam flow path 780 for discharging steam generated when hot water is heated and a safety valve 190 in the hot water module 170. Accordingly, it is possible to prevent excessive increase in pressure of the inside of the hot water tank included in the hot water module 170 due to steam. The safety valve 190 is configured to be opened at a set pressure, and can have various structures within a range in which steam in the hot water tank can be discharged smoothly.

In some examples, the steam flow path 780 can also be connected to the drain flow path 770. Accordingly, steam discharged from the hot water tank can also be discharged to the outside of the water purifier 10 through the drain flow path 770.

In some implementations, since hot water sterilization proceeds while water is continuously discharged, there is also an advantage in that foreign substances can be simultaneously removed while sterilization of the flow path and valve proceeds according to the flow rate.

In some implementations, a portion of the hot water generated during hot water sterilization and hot water washing of the entire flow path included in the water purifier is discharged through the water outlet nozzle, and the rest can be drained to the outside of the water purifier, and thus there is also an advantage in that as a large amount of hot water is discharged through the water outlet nozzle, it is possible to prevent safety accidents such as burns that can occur, and user can avoid the hassle of having to process large amounts of hot water.

In some implementations, the front panel 112 is removed when replacing the filter 120. In some examples, while the filter 120 is separated or replaced, raw water introduced into the side of the filter 120 can be blocked.

For example, instead of directly detecting the mounting of the filter 120, a separate detection sensor installed inside the water purifier main body 100 detects whether the front panel 112 is mounted, and, during the filter 120 is replaced, the water supply valve 630 is blocked so that raw water is not introduced into the filter 120, and thus problems such as water leakage can be prevented.

In some examples, when the filter 120 is replaced, the filter 120 needs to be cleaned. Then, the water that washes the filter 120 has to be drained.

To this end, when the controller detects the mounting of the front panel 112 by a separate detection sensor, the controller can control the water outlet flow path 760 so that the water in the water outlet flow path 760 does not flow toward the water outlet nozzle 300 and passes through the drain flow path 770 to drain to the outside.

In other words, when the front panel 112 is separated to replace the filter, a separate detection sensor detects the separation of the front panel 112, and the controller recognizes the separation of the front panel 112 through the detection sensor.

In some examples, the water supply valve 630 is blocked so that the introduction of raw water toward the filter 120 is blocked. In addition, the replacement of the filter 120 proceeds in a state where the introduction of raw water is blocked. Then, when the replacement of the filter 120 is completed and the front panel 112 is mounted, the detection sensor detects the mounting of the front panel 112, and the controller recognizes the mounting of the front panel 112 through the detection sensor. Then, the water supply valve 630 is opened so that raw water is introduced into the filter 120. Then, the filter 120 is washed.

In some cases, the water outlet valve 670 is controlled so that the water that washes the filter 120 is not supplied to the water outlet nozzle 300.

According to the control of the controller, the water outlet valve 670 blocks the outlet of the water outlet nozzle 300 and opens the outlet toward the drain flow path 770.

Thereafter, when the set time elapses or when the drain of the set flow rate is completed, the drain ends.

In addition, washing of the filter 120 can be performed for a set time or by a set flow rate. In addition, the washing of the filter 120 can proceed as much as the user desires, and the washing of the filter can be finished when the user inputs the end of filter washing through the manipulation portion or the like.

When the washing of the filter 120 is finished, the controller can block the water outlet valve 670 to terminate the drain.

In some implementations, when the water purifier is installed, the location of the water purifier module can be set in consideration of a direction convenient for a user to approach. In general, since the directions in which users approach the water purifier are consistent, when the user sets the location of the water outlet module and fixes the water outlet module to the main body of the water purifier, the user can conveniently access the water outlet module at any time.

In addition, since the water outlet module is elevated while being fixed to the main body of the water purifier, even if a force is applied to the water outlet module in a horizontal direction, the water outlet module can be stably elevated.

In addition, the position of the horizontal position of the water outlet nozzle is fixed in one direction, and the position in the vertical direction can be changed according to the height of the container.

What is claimed is:

1. A water purifier comprising:
a filter bracket connected to a water supply flow path, the filter bracket being configured to couple to a filter, the filter comprising (i) a filter main body and (ii) a filter head disposed at an upper end of the filter main body,
wherein the filter bracket and the filter head are configured to couple to each other in a horizontal direction and to separate from each other in the horizontal direction,
wherein the filter head comprises (i) an incoming pipe that extends in the horizontal direction and is configured to guide water to the filter main body and (ii) a discharge pipe that extends parallel to the incoming pipe and is configured to discharge water from the filter main body, and
wherein the filter bracket defines:
a first groove that extends in the horizontal direction and is configured to receive the incoming pipe in the horizontal direction, and
a second groove that extends in the horizontal direction and is configured to receive the discharge pipe in the horizontal direction.

2. The water purifier of claim 1, wherein the filter bracket comprises a blocking wall that is disposed between the first groove and the second groove and partitions the first groove and the second groove from each other.

3. The water purifier of claim 1, wherein the filter bracket comprises a main flow path that extends in a lateral direction intersecting the horizontal direction, the main flow path having (i) an inlet side configured to receive raw water from the water supply flow path and (ii) an outlet side configured to discharge purified water from the filter main body,
wherein the first groove of the filter bracket is configured to supply the raw water received through the inlet side of the main flow path to the filter main body through the incoming pipe of the filter head, and
wherein the second groove of the filter bracket is configured to receive the purified water discharged from the discharge pipe of the filter head and to discharge the purified water through the outlet side of the main flow path.

4. The water purifier of claim 3, wherein the filter bracket further comprises:
an inlet flow path connected to the inlet side of the main flow path and configured to provide the raw water to the main flow path; and
a water outlet flow path connected to the outlet side of the main flow path and configured to discharge the purified water.

5. The water purifier of claim 3, wherein at least one end portion of the main flow path defines an opening, and
wherein the filter bracket comprises a stopper that is inserted into and blocks the opening of the at least one end portion of the main flow path.

6. The water purifier of claim 5, wherein the main flow path has a first stepped portion that is defined at an inner surface of the at least one end portion of the main flow path, and
wherein the stopper has a second stepped portion that faces the first stepped portion.

7. The water purifier of claim 1, wherein the water purifier is configured to receive a plurality of filters,
wherein the filter bracket is one of a plurality of filter brackets including:
a first filter bracket configured to receive one of the plurality of filters, and
a second filter bracket connected to one side of the first filter bracket and configured to receive another of the plurality of filters.

8. The water purifier of claim 1, further comprising a water purifier main body,
wherein the filter bracket comprises an extension wall that extends downward and is fixed to the water purifier main body of the water purifier.

9. The water purifier of claim 1, further comprising:
a fixing member rotatably disposed at the filter bracket and configured to selectively fix the filter head to the filter bracket, the fixing member being configured to rotate about an axis crossing the horizontal direction.

10. The water purifier of claim 9, wherein the fixing member is configured to rotate in a forward direction toward the filter head,
wherein the filter head comprises a side portion that is convex in the forward direction and configured to contact at least a portion of the fixing member based on the fixing member rotating in the forward direction, and
wherein the fixing member is configured to restrict movement of the filter head based on rotating in the forward direction and contacting the side portion of the filter head.

11. The water purifier of claim 9, wherein the fixing member comprises a gripping portion that extends outward from a lower end of the fixing member and enables handling of the fixing member.

12. The water purifier of claim 9, wherein the filter bracket comprises:
a first protrusion that extends in the horizontal direction and defines the first groove therein;
a second protrusion that extends in the horizontal direction defines the second groove therein;
a first shaft portion that extends outward from the first protrusion in a first direction; and
a second shaft portion that extends outward from the second protrusion in a second direction opposite to the first direction, and
wherein end portions of the fixing member are rotatably coupled to the first and second shaft portions, respectively.

13. The water purifier of claim 9, wherein the filter head comprises a locking protrusion that protrudes forward from a front surface of the filter head, and
wherein the fixing member defines a locking groove configured to couple to the locking protrusion based on the fixing member rotating forward toward the filter head.

14. The water purifier of claim 1, wherein the filter main body comprises a filter cap coupled to the filter head, the filter cap comprising a protrusion, and
wherein the filter head defines an opening that exposes the protrusion of the filter cap to an outside of the filter head.

15. The water purifier of claim 14, wherein the filter head comprises a rib that is coupled to one side surface of the protrusion based on being elastically deformed, the rib being disposed at a side of the opening and exposed to the outside of the filter head through the opening.

16. The water purifier of claim 15, wherein the rib has a convex shape toward an inside of the filter head.

17. The water purifier of claim 1, further comprising:
a water purifier main body configured to accommodate the filter, the water purifier main body comprising:
a front panel that defines a front surface of the water purifier,
a first side panel and a second side panel that defines side surfaces of the water purifier, respectively,
a top cover that defines an upper surface of the water purifier,
a rear cover that defines a rear surface of the water purifier, and
a base that defines a bottom surface of the water purifier, the base defining a filter groove that is recessed downward and configured to accommodate a lower end of the filter main body;
a fixed cover fixed to the top cover of the water purifier main body, the fixed cover defining an elevation space therein that extends in a vertical direction;
a water outlet nozzle exposed to a lower end of the fixed cover; and
a filter housing disposed inside the water purifier main body, the filter housing defining a filter accommodating groove that is recessed rearward away from the front panel and configured to accommodate the filter.

18. The water purifier of claim 17, wherein the filter groove is one of a plurality of filter grooves that are defined at the base and configured to accommodate lower ends of a plurality of filters, respectively.

19. The water purifier of claim 18, wherein the base comprises intermediate protrusions that are disposed between the plurality of filter grooves and partition the plurality of filter grooves from one another.

20. The water purifier of claim 17, wherein the front panel is configured to be separated from the water purifier main body to thereby expose the filter accommodating groove or the filter accommodated in the filter accommodating groove to an outside of the water purifier.
